(19) United States
(12) Patent Application Publication
(10) Pub. No.: US 2025/0111283 A1
(43) Pub. Date: Apr. 3, 2025

(54) CORRELATION BASED DATA EXTRACTION USING MACHINE LEARNING

(71) Applicant: ADP, Inc., Roseland, NJ (US)

(72) Inventors: Chandra Sekhar Sarmah, Hyderabad (IN); Ananya Nagar, Hyderabad (IN); Arindam Das, Hyderabad (IN); Umamaheswara Raju Pothuri, Andhra Pradesh (IN); Ravi Kishan Shahani, Telangana (IN)

(73) Assignee: ADP, Inc., Roseland, NJ (US)

(21) Appl. No.: 18/900,262

(22) Filed: Sep. 27, 2024

(30) Foreign Application Priority Data
Sep. 29, 2023 (IN) 202311065524

(51) Int. Cl. G06N 20/00

(52) U.S. Cl. CPC G06N 20/00

(57) ABSTRACT

A system can include one or more memory devices that can store instructions thereon. The instructions can, when executed by one or more processors, cause the one or more processors to receive training data to indicate correlations between a plurality of parameters of a plurality of entities and a plurality of metrics of the plurality of entities, train a machine learning model to identify the correlations between the plurality of parameters and the plurality of metrics, detect a selection to indicate a change to a first parameter associated with a first entity of the plurality of entities, identify a second plurality of metrics associated with the first parameter, transmit a first Application Programming Interface (API) call to receive first values associated with the second plurality of metrics, generate a prediction to indicate a plurality of changes to the first values, generate and display a user interface.

### CROSS-REFERENCE TO RELATED PATENT APPLICATIONS

This application claims the benefit of and priority to Indian Provisional Patent Application No. 202311065524, filed Sep. 29, 2023, the entirety of which is incorporated by reference herein.

### BACKGROUND

Organization can generate and process large amounts of computing data. While processing such large amounts of computing data can be computationally resource intensive, it can further be challenging to reliably and accurately process such data in an efficient and consistent manner.

### SUMMARY

Aspects of the technical solutions of this disclosure can be directed to correlation based data extraction using machine learning. For example, it can be technically challenging to generate correlations between entities and/or data associated with different entities given that information associated with the entities are maintained in various formats across disparate systems. Aspects of the technical solutions of this disclosure can extract and aggregate data from disparate systems to generate a uniform database which includes information associated with different entities. Advantageously, one or models (e.g., machine learning models, artificial intelligence models, etc.) can utilize the aggregated data to generate outputs, which represent correlations between disparate systems. The outputs can be utilized to generate subsequent control decisions regarding one or more entities for which the correlations relate to.

At least one embodiment relates to a system. The system can include one or more memory devices. The one or more memory devices can include instructions. The instructions can, when executed by one or more processors, cause the one or more processors to receive, from a cloud system, training data to indicate correlations between a plurality of parameters of a plurality of entities and a plurality of metrics of the plurality of entities. The instructions can cause the one or more processors to train, using the training data, a machine learning model to identify the correlations between the plurality of parameters and the plurality of metrics. The instructions can cause the one or more processors to detect, via a display device, a selection to indicate a change to a first parameter associated with a first entity of the plurality of entities. The instructions can cause the one or more processors to identify, using the machine learning model, a second plurality of metrics associated with the first parameter. The machine learning model can identify the second plurality of metrics responsive to a detection of a plurality of correlations between the first parameter and the second plurality of metrics. The instructions can cause the one or more processors to transmit, to the cloud system, a first Application Programming Interface (API) call to receive first values associated with the second plurality of metrics. The first values can pertain to the first entity. The instructions can cause the one or more processors to generate, using the machine learning model, a prediction to indicate a plurality of changes to the first values responsive to implementation of the change. The instructions can cause the one or more processors to generate, responsive to generation of the prediction, a user interface to identify the plurality of changes. The instructions can cause the one or more processors to display, via the display device, the user interface.

At least one embodiment relates to a method. The method can include receiving, by one or more processing circuits, from a cloud system, training data to indicate correlations between a plurality of parameters of a plurality of entities and a plurality of metrics of the plurality of entities. The method can include training, by the one or more processing circuits, using the training data, a machine learning model to identify the correlations between the plurality of parameters and the plurality of metrics. The method can include detecting, by the one or more processing circuits, via a display device, a selection to indicate a change to a first parameter associated with a first entity of the plurality of entities. The method can include identifying, by the one or more processing circuits, using the machine learning model, a second plurality of metrics associated with the first parameter. The machine learning model can identify the second plurality of metrics responsive to a detection of a plurality of correlations between the first parameter and the second plurality of metrics. The method can include transmitting, by the one or more processing circuits, to the cloud system, a first Application Programming Interface (API) call to receive first values associated with the second plurality of metrics. The first values can pertain to the first entity. The method can include generating, by the one or more processing circuits, using the machine learning model, a prediction to indicate a plurality of changes to the first values responsive to implementation of the change. The method can include generating, by the one or more processing circuits, responsive to generation of the prediction, a user interface to identify the plurality of changes. The method can include displaying, by the one or more processing circuits, via the display device, the user interface.

At least one embodiment relates to one or more non-transitory storage medium. The one or more non-transitory storage medium can have instructions stored thereon. The instructions can, when executed by one or more processors, cause the one or more processors to perform operations that include receiving, from a cloud system, training data to indicate correlations between a plurality of parameters of a plurality of entities and a plurality of metrics of the plurality of entities. The operations can include training, using the training data, a machine learning model to identify the correlations between the plurality of parameters and the plurality of metrics. The operations can include detecting, via a display device, a selection to indicate a change to a first parameter associated with a first entity of the plurality of entities. The operations can include identifying, using the machine learning model, a second plurality of metrics associated with the first parameter. The machine learning model can identify the second plurality of metrics responsive to a detection of a plurality of correlations between the first parameter and the second plurality of metrics. The operations can include transmitting, to the cloud system, a first Application Programming Interface (API) call to receive first values associated with the second plurality of metrics. The first values can pertain to the first entity. The operations can include generating, using the machine learning model, a prediction to indicate a plurality of changes to the first values responsive to implementation of the change. The operations can include generating, responsive to generation of the prediction, a user interface to identify the plurality of changes. The operations can include displaying, via the display device, the user interface.

At least one embodiment relates to a system. The system can include one or more memory devices. The one or more memory devices can include instructions. The instructions can, when executed by one or more processors, cause the one or more processors to detect, via a display device, a selection of a first set of parameters pertaining to a first entity. The instructions can cause the one or more processors to determine, responsive to detection of the selection, a plurality of characteristics associated with the first entity. The instructions can cause the one or more processors to identify, based on the plurality of characteristics associated with the first entity, a plurality of entities. The plurality of entities can include a second plurality of characteristics having similarities to the plurality of characteristics. The instructions can cause the one or more processors to transmit, responsive to identification of the plurality of entities, a first Application Programming Interface (API) call to a cloud system, the first API call to request first information associated with the plurality of entities. The first information associated with the plurality of entities can include first values associated with the first set of parameters. The instructions can cause the one or more processors to retrieve, from a database, second information associated with the first entity. The second information associated with the first entity can include second values associated with the first set of parameters. The second information associated with the first entity can be structured based on a plurality of components of the first entity. The instructions can cause the one or more processors to generate, responsive to retrieval of the second information associated with the first entity, a user interface. The user interface can include a first section to identify third information associated with a component of the plurality of components, a second section to identify the second information associated with the first entity, and a third section to identify the first information associated with the plurality of entities. The instructions can cause the one or more processors to display, via the display device, the user interface.

At least one embodiment relates to a method. The method can include detecting, by one or more processing circuits, via a display device, a selection of a first set of parameters pertaining to a first entity. The method can include determining, by the one or more processing circuits, responsive to detection of the selection, a plurality of characteristics associated with the first entity. The method can include identifying, by the one or more processing circuits, based on the plurality of characteristics associated with the first entity, a plurality of entities. The plurality of entities can include a second plurality of characteristics having similarities to the plurality of characteristics. The method can include transmitting, by the one or more processing circuits, responsive to identification of the plurality of entities, a first Application Programming Interface (API) call to a cloud system, the first API call to request first information associated with the plurality of entities. The first information associated with the plurality of entities can include first values associated with the first set of parameters. The method can include retrieving, by the one or more processing circuits, from a database, second information associated with the first entity. The second information associated with the first entity can include second values associated with the first set of parameters. The second information associated with the first entity can be structured based on a plurality of components of the first entity. The method can include generating, by the one or more processing circuits, responsive to retrieval of the second information associated with the first entity, a user interface. The user interface can include a first section to identify third information associated with a component of the plurality of components, a second section to identify the second information associated with the first entity, and a third section to identify the first information associated with the plurality of entities. The method can include displaying, by the one or more processing circuits, via the display device, the user interface.

At least one embodiment relates to one or more non-transitory storage medium. The one or more non-transitory storage medium can have instructions stored thereon. The instructions can, when executed by one or more processors, cause the one or more processors to perform operations that include detecting, via a display device, a selection of a first set of parameters pertaining to a first entity. The operations can include determining, responsive to detection of the selection, a plurality of characteristics associated with the first entity. The operations can include identifying, based on the plurality of characteristics associated with the first entity, a plurality of entities. The plurality of entities can include a second plurality of characteristics having similarities to the plurality of characteristics. The operations can include transmitting, responsive to identification of the plurality of entities, a first Application Programming Interface (API) call to a cloud system, the first API call to request first information associated with the plurality of entities. The first information associated with the plurality of entities can include first values associated with the first set of parameters. The operations can include retrieving, from a database, second information associated with the first entity. The second information associated with the first entity can include second values associated with the first set of parameters. The second information associated with the first entity can be structured based on a plurality of components of the first entity. The operations can include generating, responsive to retrieval of the second information associated with the first entity, a user interface. The user interface can include a first section to identify third information associated with a component of the plurality of components, a second section to identify the second information associated with the first entity, and a third section to identify the first information associated with the plurality of entities. The operations can include displaying, via the display device, the user interface.

### BRIEF DESCRIPTION OF THE DRAWINGS

Variations are described in the detailed description which follows, in reference to the noted plurality of drawings by way of non-limiting examples of exemplary embodiments of the present disclosure.

FIG. 1 is an illustrative architecture of a computing system implemented in embodiments of the present disclosure.

FIG. 2 shows an exemplary cloud computing environment in accordance with aspects of the present disclosure.

FIG. 3A depicts a flow diagram for a process in accordance with aspects of the present disclosure.

FIG. 3B depicts a flow diagram for a process in accordance with aspects of the present disclosure.

FIG. 4 depicts a user interface in accordance with aspects of the present disclosure.

FIG. 5 depicts a user interface in accordance with aspects of the present disclosure.

FIG. 6A depicts a user interface in accordance with aspects of the present disclosure.

FIG. 6B depicts a user interface in accordance with aspects of the present disclosure.

FIG. 7A depicts a user interface in accordance with aspects of the present disclosure.

FIG. 7B depicts a user interface in accordance with aspects of the present disclosure.

FIG. 8A depicts a user interface in accordance with aspects of the present disclosure.

FIG. 8B depicts a user interface in accordance with aspects of the present disclosure.

FIG. 9A depicts a user interface in accordance with aspects of the present disclosure.

FIG. 9B depicts a user interface in accordance with aspects of the present disclosure.

FIG. 10A depicts a user interface in accordance with aspects of the present disclosure.

FIG. 10B depicts a user interface in accordance with aspects of the present disclosure.

FIG. 11A depicts a user interface in accordance with aspects of the present disclosure.

FIG. 11B depicts a user interface in accordance with aspects of the present disclosure.

FIG. 12A depicts a user interface in accordance with aspects of the present disclosure.

FIG. 12B depicts a user interface in accordance with aspects of the present disclosure.

FIG. 13A depicts a user interface in accordance with aspects of the present disclosure.

FIG. 13B depicts a user interface in accordance with aspects of the present disclosure.

FIG. 14A depicts a user interface in accordance with aspects of the present disclosure.

FIG. 14B depicts a user interface in accordance with aspects of the present disclosure.

FIG. 15 depicts a user interface in accordance with aspects of the present disclosure.

FIG. 16A depicts a user interface in accordance with aspects of the present disclosure.

FIG. 16B depicts a user interface in accordance with aspects of the present disclosure.

FIG. 17 depicts an architecture in accordance with aspects of the present disclosure.

### DETAILED DESCRIPTION

The present disclosure relates generally to methods, computer systems, and computer readable media for comparing different metrics from selected employment data and, more particularly, to methods, computer systems, and computer readable media for comparing employee pay and/or other employee benefits (e.g., employee rewards) within or external to an organization and provide recommendations for organization seeing review of their compensation packages. In more specific embodiments, the methods, computer products, and computer systems (hereinafter referred to also as “tool(s)”) allow organizations to evaluate and make employee decisions related to the efficient retention and hiring of employees. Accordingly, and advantageously, in a practical application, the tools described herein can be used to evaluate employee pay and/or other benefits in order to reduce employee turnover rates, increase employee retention rates and/or make the organization more competitive with overall employment compensation.

The present disclosure relates generally to methods, computer systems, and computer readable media for using employment data to adjust budgets and, more particularly, to methods, computer systems, and computer readable media for recommending, adjusting and/or customizing budgets based on employee compensation and/or comparisons to other organizations. In more specific embodiments, recommended budgets may be adjusted, customized and/or otherwise modified. The budgets may be a compilation of employee compensation and comparisons to budgets of other organizations within, for example, a particular landscape or demographic. In this way, the methods, computer products, and computer systems (hereinafter referred to also as “tool(s)”) can be used to ensure competitiveness within an industry, etc., e.g., reduce employee turnover rates, increase employee retention rates and/or make the organization more competitive with overall employment compensation.

In embodiments, the tools allow users to analyze employee rewards within an organization or external to an organization and make employment decisions by comparing the employee rewards for a particular business unit or group selected by or associated with an organization across particular landscapes. The compared landscapes may be related to a particular subset of business units within an organization (e.g., given department or location or business unit of the same company), a general landscape of the organization and an entire marketplace (e.g., market/industry benchmarks in which the company is operating). The comparison may also include different core metrics (e.g., human resource metrics) such as headcount, turnover rate, offer to higher ratio, time to fill positions, retention rate, etc. These comparisons may be used to formulate and provide recommendations to an organization seeking review of their compensation packages in order to (i) be more competitive in the marketplace, (ii) better retain employees and/or (iii) have an improved hiring ratio, amongst other practical applications, in comparison to known benchmarks (e.g., data used to train from different organizations or subsets thereof provided in existing databases as described in more detail herein).

In more specific embodiments, the tools allow users to analyze employee rewards (e.g., employee compensation) and organizational allocations (internal and external) to make organizational decisions such as adjusting resource allocations associated with employee pay and benefits (e.g., employee rewards). For example, in embodiments, the employee rewards may be compared to employee rewards of organizations within different landscapes, i.e., related to a particular subset of business units within an organization (e.g., department or location or business unit of the same company), a general landscape of the organization and/or an entire marketplace (e.g., market/industry benchmarks in which the company is operating) or subset thereof. The comparisons may be based on different core metrics (e.g., human resource metrics) such as headcount, turnover rate, offer to higher ratio, time to fill positions, retention rate, acceptance rate, etc., different demographics and/or different types of rewards as described herein. Based on the comparison and/or other factors such as budgets of organizations within a particular selected landscape, etc., the tool provides recommendations and further allows the user to make adjustments and/or modifications to the recommendations. These adjustments, in turn, can be correlated to employee retention, employee acceptance rates, etc. In this way, the initial recommendations can be adjusted or modified by the organization to fit their specific budget constraints in order to (i) be more competitive in the marketplace, (ii) better retain employees and/or (iii) have an improved hiring ratio, amongst other practical applications.

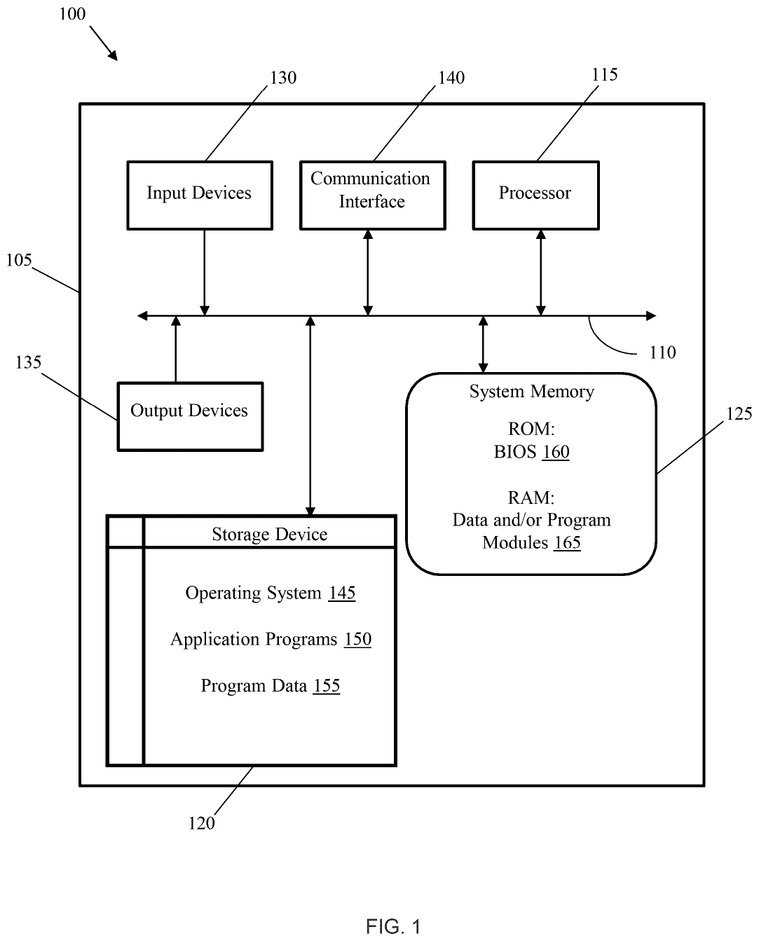

FIG. 1 is an illustrative architecture of a computing system or computer system 100 implemented in embodiments of the present disclosure. The computer system 100 is only one example of a suitable computing system and is not intended to suggest any limitation as to the scope of use or functionality of the disclosure. Also, computer system 100 should not be interpreted as having any dependency or requirement relating to any one or combination of components illustrated in computer system 100.

As shown in FIG. 1, computer system 100 includes a computing device 105. The computing device 105 can be resident on a network infrastructure such as within a cloud environment or may be a separate independent computing device (e.g., a computing device of a third party service provider). The computing device 105 may include a bus 110, a processor 115, a storage device 120, a system memory (hardware device) 125, one or more input devices 130, one or more output devices 135, and a communication interface 140.

The bus 110 permits communication among the components of computing device 105. For example, bus 110 may be any of several types of bus structures including a memory bus or memory controller, a peripheral bus, and a local bus using any of a variety of bus architectures to provide one or more wired or wireless communication links or paths for transferring data and/or power to, from, or between various other components of computing device 105.

The processor 115 may be one or more processors or microprocessors that include any processing circuitry operative to interpret and execute computer readable program instructions, such as program instructions for controlling the operation and performance of one or more of the various other components of computing device 105. The processor 115 may collect, sort, and analyze employee data, from various disparate systems such as sources associated with benefits, payroll, and human resources, and use this data to compare employee compensation related to other organizations or different business units within the organization. This employee compensation data also referred to as employee rewards may be any type of compensation or benefits as described herein, e.g., type of pay, work-life issues, time off, recognitions and career development, as examples, which are analyzed, collated, and compared in order to make the employer competitive within a marketplace. More specifically, the compared rewards or employee compensation may be, for example, net pay, benefits, work life balance, time off, etc., as further discussed herein, and may be categorized using many factors including demographics, location, job title, job description, tenure, technical capabilities, etc. The information may be categorized into different domains and provided as comparisons of core metrics such as headcount, turnover rate, offer to hire, time to fill (a position), etc. The comparison data can also be visualized or displayed on a graphical user interface (GUI) on a user device. The data can be used to formulate and make recommendations to organizations seeking review of their compensation package in order to be more compensative in the marketplace and/or to decrease turnover rate (attrition) and increase offer to hire and time to fill a position, as examples. These features are described in more detail below.

The processor 115 may collect, sort, aggregate and analyze employee data from various disparate systems such as sources associated with benefits, payroll, and human resources, and use this data to compare employee compensation between organizations or different business units within an organization. The comparison data can be used to recommend a budget of the organization to, for example, meet expected obligations, align with other organizations within a particular landscape and/or compare budgets of similarly situation organizations to ensure competitiveness in the marketplace.

The recommended budgets can be customized, e.g., modified and/or adjusted, depending on an organization's budget constraints or other factors, and these customizations can be used to compare how they would perform against the recommended budget itself. For example, the processer 115 may provide minimum budget recommendations, alignment budgets with other organizations, allow for customizations to such budgets, show how they compare to the recommendations and alignments and/or how these adjustments may affect employee retention, acceptance for hiring, etc. The processer 115 may also provide confidence levels for each of the different categories, e.g., recommended, alignment and custom, and how an adjustment to a recommendation may affect a certain outcome of employment. The recommended and customized budgets can be visualized or displayed on a graphical user interface (GUI) on a user device using a line-by-line comparison of employee rewards.

The compared budgetary information may be, for example, line-by-line comparisons of compensation, benefits, work life balance, time off, recognition, career development or other employee rewards, within a certain landscape or using certain other criteria such as demographics, core metrics (e.g., human resource metrics), etc. The employee compensation (also referred to as employee rewards) may be any employee benefits paid by the employer, e.g., salary, stock options, health, and life insurance benefits, leave, work at home, etc. More specifically, the compensation may be, e.g., base pay, variable pay, severance pay, overtime pay, commission pay, etc. Other rewards may be benefits, time off, recognitions, career development, work-life issues, e.g., employee wellness investment, work from home allowances, gym membership, etc., as examples. Core metrics used for comparison purposes may be, e.g., different core metrics (e.g., human resource metrics) such as headcount, turnover rate, offer to higher ratio, time to fill positions, retention rate, etc.

The data used in the comparison, recommendations and/or adjustments may be based on different demographics including, but not limited to, e.g., age group, ethnicity, employee cultural background, technical field in which employees work or have a background in, employee length of work experience, employee average tenure, full time or part time employment, population or population density at the location of employees' current place of employment, education, etc. Also, the comparisons, recommendations and/or adjustments may be based on different landscapes including a business unit or group in a same or different organization and/or geographic location, or external to an organization's marketplace or subset thereof, or an entire marketplace or other criteria. The marketplace, for example, may be a plurality of different companies related to or unrelated to the organization. For example, the marketplace may be any company within the Fortune 50, 100, 500, 1000, etc., within a particular technical field or industry, etc.

In embodiments, processor 115 interprets and executes the processes, steps, functions, and/or operations of the present disclosure, which may be operatively implemented by the computer readable program instructions. In embodiments, processor 115 may receive input signals from one or more input devices 130 and/or drive output signals through one or more output devices 135. The input devices 130 may be, for example, one or more mechanisms that permit an operator to input information to computing device 105 such as a keyboard, touch sensitive user interface (UI), etc. The one or more output devices 135 may include one or more mechanisms that output information to an operator, e.g., any display device, printer, etc.

The storage device 120 may include removable/non-removable, volatile/non-volatile computer readable media, such as, but not limited to, non-transitory media such as magnetic and/or optical recording media and their corresponding drives. The drives and their associated computer readable media provide for storage of computer readable program instructions, data structures, program modules and other data for operation of computing device 105 in accordance with the different aspects of the present disclosure. In embodiments, storage device 120 may store operating system 145, application programs 150, and program data 155 in accordance with aspects of the present disclosure.

The system memory 125 may include one or more storage mediums, including for example, non-transitory media such as flash memory, permanent memory such as read-only memory (“ROM”), semi-permanent memory such as random access memory (“RAM”), any other suitable type of storage component, or any combination thereof. In some embodiments, an input/output system 160 (BIOS) including the basic routines that help to transfer information between the various other components of computing device 105, such as during start-up, may be stored in the ROM. Additionally, data and/or program modules 165, such as at least a portion of operating system 145, application programs 150, and/or program data 155, that are accessible to and/or presently being operated on by processor 115 may be contained in the RAM.

The communication interface 140 may include any transceiver-like mechanism (e.g., a network interface, a network adapter, a modem, or combinations thereof) that enables computing device 105 to communicate with remote devices or systems, such as a mobile device or other computing devices such as, for example, a server in a networked environment, e.g., cloud environment. For example, computing device 105 may be connected to remote devices or systems via one or more local area networks (LAN) and/or one or more wide area networks (WAN) using communication interface 140.

As discussed herein, computer system 100 may be configured to carryout acts or steps described herein, which may include collecting, sorting, and selecting employment data based on user requests, performing calculations and/or analyzing the data, and generating a comparison of at least two sets of data which may be produced, visualized, or displayed on a GUI. In particular, computing device 105 may perform tasks (e.g., process, steps, methods and/or functionality) in response to processor 115 executing program instructions contained in a computer readable medium, such as system memory 125. The program instructions may be read into system memory 125 from another computer readable medium, such as data storage device 120, or from another device via the communication interface 140 or server within or outside of a cloud environment. In embodiments, an operator may interact with computing device 105 via the one or more input devices 130 and/or the one or more output devices 135 to facilitate performance of the tasks and/or realize the end results of such tasks in accordance with aspects of the present disclosure. In additional or alternative embodiments, hardwired circuitry may be used in place of or in combination with the program instructions to implement the tasks, e.g., steps, methods and/or functionality, consistent with the different aspects of the present disclosure. Thus, the steps, methods and/or functionality disclosed herein can be implemented in any combination of hardware circuitry and software.

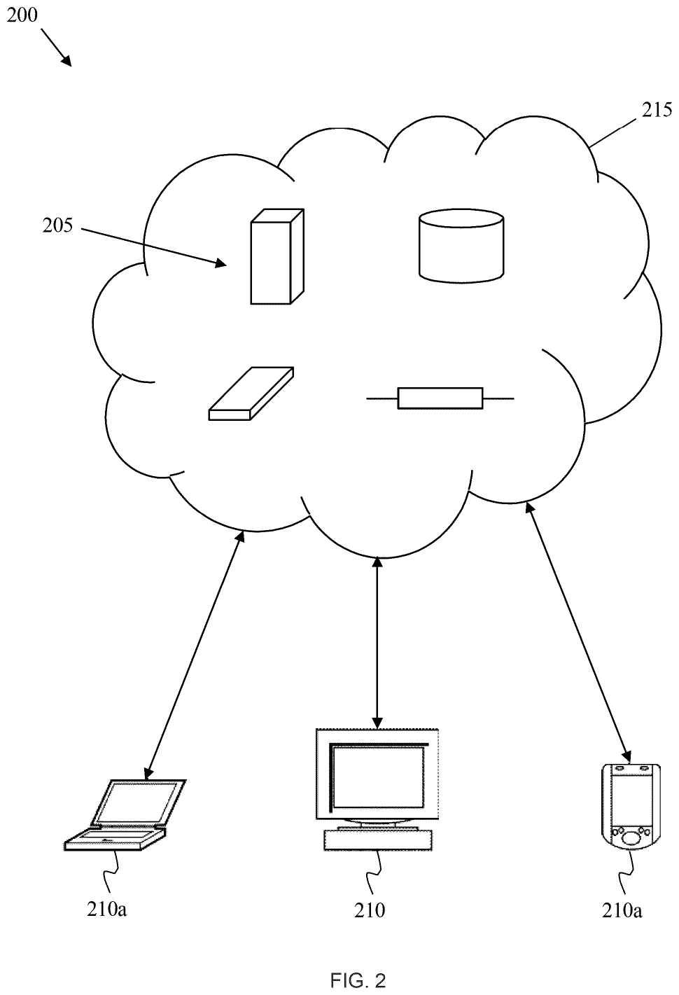

FIG. 2 shows an exemplary cloud computing environment 200 in accordance with aspects of the disclosure. Cloud computing is a computing model that enables convenient, on-demand network access to a shared pool of configurable computing resources, e.g., networks, servers, processing, storage, applications, and services, which can be provisioned and released rapidly, dynamically, and with minimal management efforts and/or interaction with the service provider. In embodiments, one or more aspects, functions and/or processes described herein may be performed and/or provided via cloud computing environment 200.

As depicted in FIG. 2, cloud computing environment 200 includes cloud resources 205 that are made available to user devices 210 via a network 215, such as the Internet. Cloud resources 205 can include a variety of hardware and/or software computing resources, such as servers, databases, storage, networks, applications, and platforms. Cloud resources 205 may be on a single network or a distributed network. Cloud resources 205 may be distributed across multiple cloud computing systems and/or individual network enabled computing devices. User devices 210 may comprise any suitable type of network-enabled computing device, such as servers, desktop computers, laptop computers, handheld computers (e.g., smartphones, tablet computers), set top boxes, and network-enabled hard drives. Cloud resources 205 are typically provided and maintained by a service provider so that a user does not need to maintain resources on a local user device 210. In embodiments, cloud resources 205 may include one or more computer system 100 of FIG. 1 that is specifically adapted to perform one or more of the functions and/or processes described herein.

Cloud computing environment 200 may be configured such that cloud resources 205 provide computing resources to user devices 210 through a variety of service models, such as Software as a Service (SaaS), Platforms as a service (PaaS), Infrastructure as a Service (IaaS), and/or any other cloud service models. Cloud resources 205 may be configured, in some cases, to provide multiple service models to a user device 210. For example, cloud resources 205 can provide both SaaS and IaaS to a user device 210. Cloud resources 205 may be configured, in some cases, to provide different service models to different user devices 210. For example, cloud resources 205 can provide SaaS to a first user device 210 and PaaS to a second user device 210.

Cloud computing environment 200 may be configured such that cloud resources 205 provide computing resources to user devices 210 through a variety of deployment models, such as public, private, community, hybrid, and/or any other cloud deployment model. Cloud resources 205 may be configured, in some cases, to support multiple deployment models. For example, cloud resources 205 can provide one set of computing resources through a public deployment model and another set of computing resources through a private deployment model.

In embodiments, software and/or hardware that performs one or more of the aspects, functions and/or processes described herein may be accessed and/or utilized by a user (e.g., an enterprise or an end user) as one or more of a SaaS, PaaS and IaaS model in one or more of a private, community, public, and hybrid cloud. Moreover, although this disclosure includes a description of cloud computing, the systems and methods described herein are not limited to cloud computing and instead can be implemented on any suitable computing environment.

Cloud resources 205 may be configured to provide a variety of functionality that involves user interaction. Accordingly, a user interface (UI) can be provided for communicating with cloud resources 205 and/or performing tasks associated with cloud resources 205. The UI can be accessed via a user device 210 in communication with cloud resources 205. The UI can be configured to operate in a variety of user modes, including a fat user mode, a thin user mode, or a hybrid user mode, depending on the storage and processing capabilities of cloud resources 205 and/or user device 210. Therefore, a UI can be implemented as a standalone application operating at the user device in some embodiments. In other embodiments, a web browser-based portal can be used to provide the UI. Any other configuration to access cloud resources 205 can also be used in various implementations.

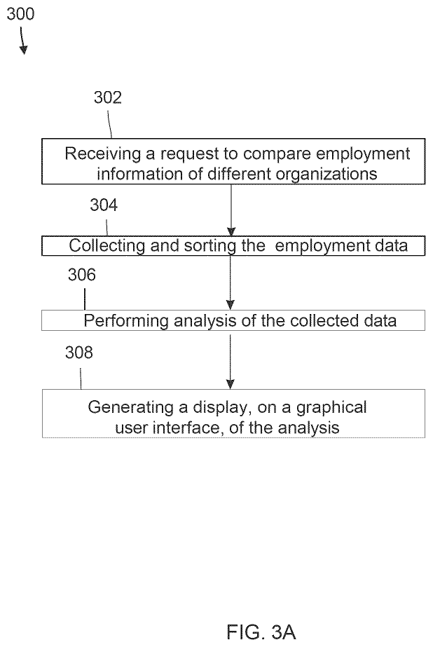

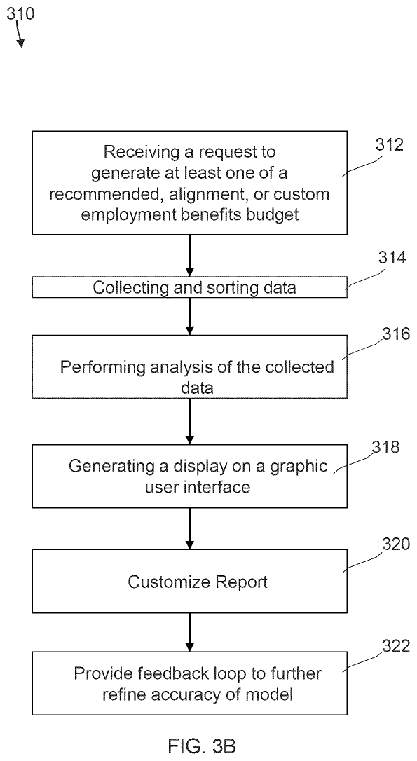

FIG. 3A depicts a flow diagram of a process 300 which may be illustrative of a system, a method, and/or a computer program product and related functionality implemented on the computing system of FIG. 1. The computer program product may include computer readable program instructions stored on computer readable storage medium (or media). The computer readable storage medium may include the one or more storage mediums as described with regard to FIG. 1, e.g., non-transitory media, a tangible device, etc. The method, and/or computer program product implementing the flow of FIG. 3A can be downloaded to respective computing/processing devices, e.g., computing system of FIG. 1 as already described herein, or implemented on a cloud infrastructure as described with regard to FIG. 2. Accordingly, the processes associated with each flow of the present disclosure can be implemented by special purpose hardware-based systems that perform the specified functions or acts or carry out combinations of special purpose hardware and computer instructions.

More specifically, FIG. 3A is a flow diagram depicting a process of comparing employment data (e.g., core metrics and employee rewards) of different organizations. In embodiments, the different organizations may be defined as organizations in a related marketplace, different business groups within the same organization (internal landscape) or any subset of the organization within or at different geographic locations, etc. It should be understood, though, that the different organizations may be any permutations of human resources data including based on job title, job description, tenure, demographics, etc. The comparisons may be between two or more organizations. The employment data (e.g., employee rewards) that are compared may include, e.g.: (i) compensation including base pay and/or other type of pay as described herein, (ii) benefits, e.g., health benefits, insurance, retirement benefits; (iii) work-life issues, e.g., home allowance, employee wellness investments, gym membership allowance; (iv) time off, etc., (v) service rewards; (vi) career development, and may be categorized by core metrics (e.g., human resource metrics) (i) turnover rate; (ii) offered to higher rate; (iii) retention rate, (iv) time to fill position, (v) headcount, etc.

At step 302, the process receives a request to compare a first set of employment information (e.g., employment data) and a second set of employment information. In some embodiments, the computing device 105 may detect one or more selections. For example, the computing device 105 may detect selections responsive to receiving the request to compare employment information. In some embodiments, the computing device 105 may receive the selection via a display device. For example, the computing device 105 may provide and/or display a user interface via a screen (e.g., a display device) and the computing device 105 may detect the selection responsive to a user interacting with and/or interfacing with the user interface.

In some embodiments, the selection may include one or more parameters. For example, the selection may include selecting a given department and/or a group of a company (e.g., an entity). As another example, the selection may include selecting benefits and/or rewards (e.g., compensation, days off, remote work, etc.). In some embodiments, a user may select an entity and one or more parameters pertaining to the entity. For example, the user may select company “A” and one or more parameters pertaining to company “A).

At step 304, the process collects and sorts the employment data relevant to the request. The data may be retrieved from different, disparate systems including payroll systems, human resources system and benefits systems, for example. The data of the first set of employment information may be already existing data which is normalized and used to train machine learning algorithms, as described herein, to provide benchmarks, and, for the existing data, make correlations such as how certain data affects certain outcomes. By way of example, the data may be used to determine how sensitive a particular reward category is to retention rates or time to fill a position. The second set of employment information may be the compensation plan and other metrics, e.g., headcount, type of industry, type of employee (job description, title, etc.) of an organization seeking review of their compensation plan.

In some embodiments, the computing device 105 may determine one or more characteristics. For example, the computing device 105 may determine characteristics for a company. In some embodiments, the characteristics may include at least one of number of individuals, yearly revenue, number of offices, domestic organization, international organization, and/or industry. For example, the selection in step 302 may be associated with an entity that performs car manufacturing (e.g., a characteristic). In some embodiments, the computing device 105 may determine the characteristics by retrieving information that pertains to the entity. For example, the computing device 105 may retrieve purchase orders associated with the entity and the computing device 105 may determine the characteristics of the entity based on the purchase orders.

At step 306, the process performs analysis of the collected data and the current metrics (e.g., compensation plan, etc.) of the organization seeking review to produce a set of comparison results associated with the first set of employment data and the second set of employment data. The analysis may be correlations of, for example, month to month headcount difference, year to data turnover rate in raw numbers and percentages, offer to hire ratio for a particular time period (e.g., year to date, month to date, etc.) and time to fill a position in days or other predetermined time period). In further embodiments, the processing of the data may be providing the data in data tables and segregating the data into different domains, e.g., human resources, payroll, benefits, etc. The comparisons may be based on different, selected employee rewards over different landscapes.

In some embodiments, the computing device 105 may identify one or more entities. For example, the computing device 105 may identify entities that have one or more similarities with the entity identify in step 302. In some embodiments, the computing device 105 may identify the entities based on the characteristics determined in step 304. For example, the computing device 105 may identify entities that are in a similar industry to that of the entity in step 302. As another example, the computing device 105 may identify entities that have a similar number of individuals.

In some embodiments, the computing device 105 may transmit one or more signals. For example, the computing device 105 may transmit signals to a remote database (e.g., cloud resources 205). As another example, the computing device 105 may transmit signals to a user device. In some embodiments, the computing device 105 may transmit Application Programming Interface (API) calls. For example, the computing device 105 may transmit an API call to receive information associated with the entities identified in step 306. In some embodiments, the computing device 105 may request, via the API call, information that includes values that are associated with the entity of step 302. For example, the computing device 105 may request information pertaining to yearly sales (e.g., a characteristic).

In some embodiments, the computing device 105 may retrieve information associated with an entity. For example, the computing device 105 may retrieve information associated with the entity of step 302. In some embodiments, the computing device 105 may retrieve the information from a database. For example, the computing device 105 may retrieve information from at least one of the various memory devices described herein.

In some embodiments, the computing device 105 may retrieve information that include one or more values associated with the parameters selected in step 302. In some embodiments, the information may be organized and/or arranged in one or more formats. For example, the information may aggregate values as well as individual values for one or more aspects of the entity. In some embodiments, the information may be structured based on components of the entity. For example, the information may be organized based on one or more divisions and/or subsets of the entity. As another example, information associated with a sales division of an entity may be separated from information associated with a warehouse division.

At step 308, the process displays the comparison results on a graphic user interface. In embodiments, the display may be provided with near real time results which are stored in a rapid access data storage device. In some embodiments, the computing device 105 may generate one or more user interfaces. For example, the computing device 105 may generate a user interface that includes sections that specify and/or indicate various types of information.

In some embodiments, the user interface may include sections that identify information associated with a given component of the plurality of components, sections that identify the information associated with the first entity, and sections identify the information associated with the plurality of entities. In some embodiments, the computing device 105 may display the user interface. For example, the computing device 105 may transmit signals to the device 210 and the device 210 may display, responsive to receipt of the signal, the user interface.

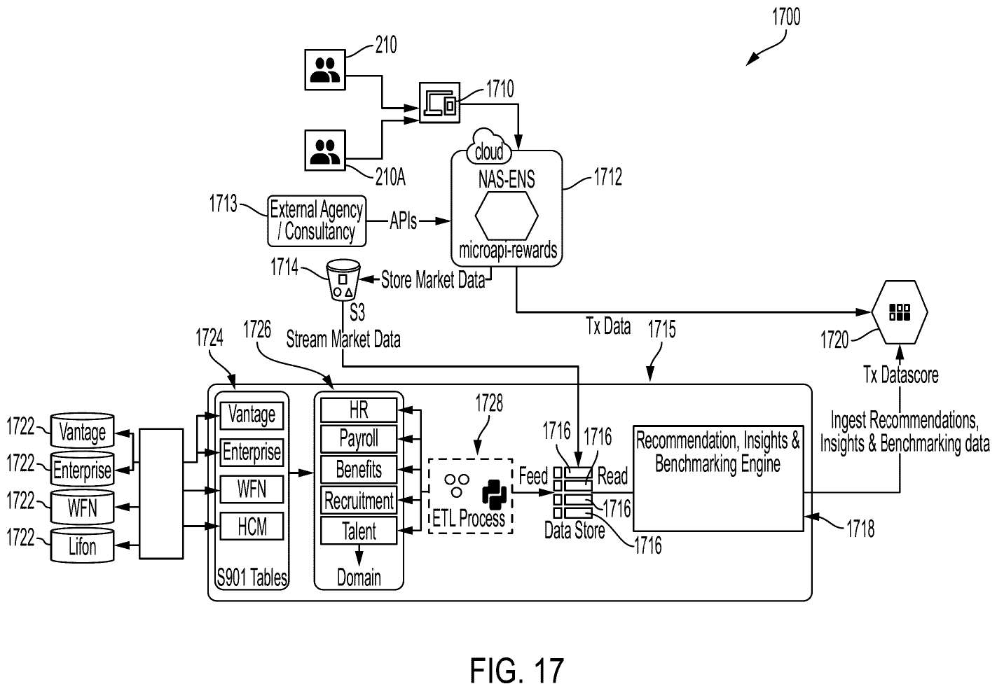

It should be understood by those of ordinary skill in the art that the processes provided herein may be provided using cloud services with microservices over a data cloud as described in more detail with respect to FIG. 17 and also discussed with respect to FIG. 2.

In some embodiments, the information associated with components of the entity may include corresponding values. For example, an entity may include a first component and a second component. To continue this example, the computing device 105 may retrieve values that are associated with parameters of the first component and the computing device 105 may retrieve values that are associated with parameters of the second component.

In some embodiments, the various user interfaces described herein may indicate and/or display information based on the various entities. For example, a user interface may include a first section that displays values associated with a first entity, a second section that displays values associated with a component of the first entity, and a third section that displays values associated with one or more second entities.

In some embodiments, the computing device 105 may detect one or more subsequent interactions and/or selections. For example, the computing device 105 may detect a selection of at least one of the sections described herein. As another example, the computing device 105 may detect a selection of a section that pertains to the entity of step 302. In some embodiments, the computing device 105 may detect a selection to change information that is displayed by the user interface. For example, the computing device 105 may detect a selection to change from a first component of the entity to a second component of the entity.

In some embodiments, the computing device 105 may identify one or more portions of the various types of information that pertain to the components. For example, the computing device 105 may identify a portion of the previously retrieved information that is associated with a subsequently selected component and/or entity. In some embodiments, the computing device 105 may update and/or adjust at least one the user interfaces described herein to display the corresponding information.

In some embodiments, the computing device 105 may provide one or more prompts. For example, the computing device 105 may prompt a user of the device 210 to select at least of the various parameters described herein. As another example, the computing device 105 may prompt the user of the device 210 to select at least one entity. In some embodiments, the computing device 105 may detect one or more selections. For example, the computing device 105 may detect a selection responsive to the computing device 105 prompting the user.

FIG. 3B is a flow diagram depicting a process of recommending and/or adjusting budgets based on recommended employee compensation and/or other organizations. FIG. 3B may be illustrative of a system, a method, and/or a computer program product and related functionality implemented on the computing system of FIG. 1. The computer program product may include computer readable program instructions stored on computer readable storage medium (or media). The computer readable storage medium may include the one or more storage mediums as described with regard to FIG. 1, e.g., non-transitory media, a tangible device, etc. The method, and/or computer program product implementing the flow of FIG. 3B can be downloaded to respective computing/processing devices, e.g., computing system of FIG. 1 as already described herein, or implemented on a cloud infrastructure as described with regard to FIG. 2. Accordingly, the processes associated with the flow can be implemented by special purpose hardware-based systems that perform the specified functions or acts or carry out combinations of special purpose hardware and computer instructions.

At step 312, the process receives a request to generate at least one of a recommended, alignment, or custom budget. At step 314, the process collects and sorts employment data relevant to the request. The data may be values (e.g., dollar amounts associated with the relevant request) retrieved from different, disparate systems including payroll systems, human resources system and benefits systems, for example. If values are not provided within the different systems, the present flow can assign values to such employee rewards in accordance with industry standards or other organizations that do, indeed, provide such values. The processes herein can also normalize the data from the different disparate systems for comparison and analysis as to how certain employee data may affect certain employee outcomes, e.g., retention, acceptance to hire, etc.

The employment data may be, in addition to budgets of different organizations, which may be in any nested form of specific employee rewards, e.g., compensation, benefits, work-life issues, time off, recognition, etc. The different organizations may be organization within the same or similar industry and/or with a same or similar market share, as illustrative examples. The different organizations may also be different business units with the same organization, and may be based on different core metrics and different demographics within the organizations, e.g., location of organization and employees, years of experience in the field, job title, job description, etc. This data may be historical data which is used by machine learning to learn how different line items of an employee compensation affect employee outcomes, as described in more detail herein.

At step 316, the process performs analysis of the collected data to produce employment data for line-by-line comparison. In embodiments, the collected data comprises the existing employee rewards for different organizations as described herein, for example, which can be used to provide a recommended budget or an alignment budget for the organization. The alignment budget may simply be a recommendation of using a same overall budget with the same employee rewards of the other organization. The process also allows the user to customize the budgets by adjusting any of the recommended employee rewards as described herein. In embodiments and as described in more detail herein, the customization may automatically make other adjustments to another line item of the employee rewards in order to meet certain criteria, and can predict how such adjustments affect an employee outcome.

The recommendation may be based on a comparison of employee compensation (e.g., employee rewards) within an organization for a specific set of categories, e.g., demographics, core metrics and landscapes as already described herein. As also described, the organizations which are to be compared may be any organization related in the marketplace, different business groups within the same organization (internal landscape) within or at different geographic locations, etc. It should further be understood that the organizations may have other permutations including subsets of an organization based on job title, job description, tenure, etc. The comparisons may include a calculation for a recommended budget of the organization based on their desired overall budget, net sales, gross sales, gross profit margins or other financial factors. The comparisons may further be based on an alignment of budgets between two or more organizations, with a recommendation that such alignment can be met by the organization. The comparisons may also allow the user to customize the budgets based on different employee rewards. This latter feature allows the user to selectively use different levers to adjust their budgets and employee compensation based on perceived importance of different compensation schemes, e.g., net pay, bonuses, benefits, etc.

In more specific embodiments, for example, the recommended budget of the organization may be proportional to the budget of another organization within the same or similar industry. Illustratively and non-limiting, the recommended budget may be based on a comparison of organizations with similar or different market shares in different geographic locations and/or current budgets, as examples. Illustratively, a total recommended budget may be ⅔ of a budget of another organization that has 3× market share, noting that some of the components of the budget, e.g., employee rewards, may be more or less than the stated ratio. In this illustrative example, the components of the budget, e.g., employee rewards, may be higher in some categories and lower in other categories due to perceived importance. As an example, base pay may be higher the same, but the bonuses may be less than ⅔ compared to the other organization.

In further embodiments, the recommended budget may be customized to provide different variations of, for example, the alignment budget. In this scenario, for example, the user can customize certain line items of the employee rewards to meet a local ordinance, law, or industry standard etc. In addition, taking into consideration other financial factors associated with the organization such as sales, net profit, operating budgets and/or other financial obligations and/or factors, the user can adjust other line items of the employee rewards in which case the tools automatically adjust other line items to meet the overall desired budget. In this latter scenario, the customized and/or recommended budget may a proportion to another organization based on, e.g., profit, operating budgets, market share within a particular technical field or industry, and other financial or market factors of the organizations that are within the same industry, etc.

At step 318, the process displays the comparison results on a graphic user interface. The comparison may be a side-by-side comparison of different rewards, e.g., base pay, bonuses, vacation days, medical benefits, between an organization's rewards and a selected benchmark. The comparison would also be a side-by-side comparison of the total budgets of the organization and the benchmark budget. It should be noted that total budget is a summation of the line-by-line rewards.

In addition, the display provides the ability to customize the recommended budget by adjusting the line items. For example, at step 308, the user can customize, e.g., adjust, any of the employee rewards as described herein. The customized results can be totaled to reveal the total budget for such customization. The display can also be provided into a report and electronically sent to other users with, for example, decision making abilities for the organization.

At step 320, the customized results can be fed back into the tools for additional learning by the machine learning algorithms, which refines the model and provides additional confidence in the results of any new comparisons and recommendations. In this way, the model will become more accurate and robust by using validated, customized data.

It should be understood by those of skill in the art that the results of the customized recommendations can be correlated with the actual outcome using existing systems which capture such outcomes, e.g., turnover rate and acceptance rate. For example, human resources systems capture the turnover rate and acceptance rates of an organization. The tools described herein can correlate this captured data directly to the adjustments made to the rewards. In this way, it is now possible to determine how a particular adjustment affected, e.g., deviated, from a particular known outcome, plug this information back into the model and use it to further refine future recommendations. For example, a change in a reward allocation can be used to determine whether a particular prediction of a particular turnover rate was accurate or how much deviation there was from such prediction.

At step 322, information can be mapped back into the model to increase the confidence of future recommendations and, in embodiments, to provide a feedback loop for constant refinement to the model using machine learning.

In some embodiments, the computing device 105 may receive one or more types of data. For example, the computing device 105 may receive training data. In some embodiments, the training data indicate correlations between the various parameters described herein. For example, the training data may indicate correlations between starting salary for a given position and an impact on an acceptance rate for the given position.

In some embodiments, the computing device 105 may train one or more models. For example, the computing device 105 may train a Machine Learning (ML). As another example, the computing device 105 may train and/or modify a pre-trained model. To continue this example, the computing device 105 may retrieve an open source ML model and the computing device 105 may train the open source ML model with the training data. In some embodiments, the computing device 105 may training the various models using and/or based on at least one of regression trees, supervised learning, unsupervised learning, nearest neighbor, neural networks, and/or other possible training techniques.

In some embodiments, the computing device 105 may detect one or more selections. For example, the computing device 105 may detect a selection of a change to a parameter of an entity. To continue this example, the change to the parameter may be a change to one or more values of the parameter. In some embodiments, the parameter may include at least one of the various parameters described herein. For example, the parameter may include starting compensation. As another example, the parameter may include vacation days. In some embodiments, the change may include changing the parameter from a first value to a second value.

In some embodiments, the computing device 105 may implement and/or use the models. For example, the computing device 105 may identify one or more metrics associated with the first parameter. As another example, the computing device 105 may identify the metrics based on correlations between the metrics and the parameters. In some embodiments, the metrics may include various entity metrics. For example, the metrics may include a retention rate for an entity. As another example, the metrics may include an acceptance rate.

In some embodiments, the computing device 105 may transmit one or more signals. For example, the computing device 105 may transmit an API call. In some embodiments, the computing device 105 may transmit the API call to receive one or more values. For example, the computing device 105 may transmit an API call to receive values that are associated with the metrics of the entity.

In some embodiments, the computing device 105 may generate one or more predictions. For example, the computing device 105 may generate predictions using the model. In some embodiments, the computing device 105 may generate a prediction to indicate a plurality of changes to one or more values. For example, the computing device 105 may generate a prediction that indicates an impact (e.g., a change) that adjusting a starting wage from a first value to a second value (e.g., a change to a parameter) may have on an acceptance rate.

In some embodiments, the computing device 105 may generate user interfaces. For example, the computing device 105 may generate user interfaces to indicate the changes that may result from implementation of the change to the parameter. In some embodiments, the user interface may include one or more sections. For example, a first section may indicate that a change of “x” amount to the parameter may result in metric “y” changing from value “a” to value “b.” In some embodiments, the computing device 105 may display the user interface.

In some embodiments, the computing device 105 may generate the training data. For example, the computing device 105 may generate the training data by monitoring changes of one or more parameters for a plurality of metrics. Stated otherwise, the computing device 105 may monitor impacts on metrics responsive to changes in values for the parameters. In some embodiments, the computing device 105 may segment the training data. For example, the computing device 105 may segment the training data into one or more portions. In some embodiments, the computing device 105 may segment the training data into portions based on characteristics of the entities. For example, a first portion of the training data may correspond to entities of a first size and a second portion of the training data may correspond to entities of a second size.

In some embodiments, the computing device 105 may identify characteristics of the entity and the computing device 105 may use the models to detect correlations responsive to identifying the characteristics. For example, the computing device 105 may determine that a first entity is associated with manufacturing (e.g., a characteristic) and the computing device 105 may use the model to detect correlations between the parameter and the metrics responsive to identifying that the entity is associated with manufacturing.

In some embodiments, the training data may be modified, adjusted, and/or otherwise changed. For example, information that is associated with an identity (e.g., a name, a title, a slogan, etc.) may be removed from the training data. Stated otherwise the computing device 105 may scrub and/or anonymize the training data so that the training data is absent information that identifies the entities.

In some embodiments, the computing device 105 may detect implementation of one or more changes. For example, the computing device 105 may detect that an entity has changed a car allowance reimbursement from a first value to a second value. As another example, the computing device 105 may detect that an entity has changed a pay scale from a first amount to a second amount.

In some embodiments, the computing device 105 may transmit signals to receive subsequent information. For example, the computing device 105 may transmit an API call to receive subsequent values for the metrics. Stated otherwise the computing device 105 may request information to that identifies values of the metrics responsive to implementation of the change.

In some embodiments, the computing device 105 may compare information. For example, the computing device 105 may compare information prior to implementation of a change with information subsequent to the change. Stated otherwise, the computing device 105 may compare values of the metrics prior to implementation of the change with values of the metrics subsequent to implementation of the change.

In some embodiments, the computing device 105 may determine one or more differences. For example, the computing device 105 may determine that a first metrics changed from a first value to a second value (e.g., a change). As another example, the computing device 105 may determine a percent change (e.g., a retention rate increased by 5%, 10%, etc.). In some embodiments, the computing device 105 may identify one or more results. For example, the computing device 105 may compare the predictions with the actual changes (e.g., what the values became responsive to implementation of the change). In some embodiments, the computing device 105 may update the model. For example, the computing device 105 may further train the model using the results determined during a comparison between the metrics before and after implementation of the change.

In some embodiments, the computing device 105 may provide one or more prompts. For example, the computing device 105 may provide prompts to the devices 210. In some embodiments, the computing device 105 may provide prompts based on a persona of a user. For example, the computing device 105 may provide a first prompt to a sales manager (e.g., a persona) and the computing device 105 may provide a second prompt to a hiring director (e.g., a persona).

Several graphic user interfaces (GUIs) and related underlying functionality are described herein in accordance with aspects of the present disclosure. For example, the displays may provide different columns associated with the different organizations that are being compared. The displays may be provided on the devices 210, 210A of FIG. 2 or within the computer system 100 of FIG. 1, for example, by way of a network 215 of FIG. 2. Moreover, it should further be understood that the comparisons may be any number of sets of employment information. These sets of employment information may include the entire marketplace compared to internal metrics compared to, for example, a particular landscape as defined by the user and further described herein.

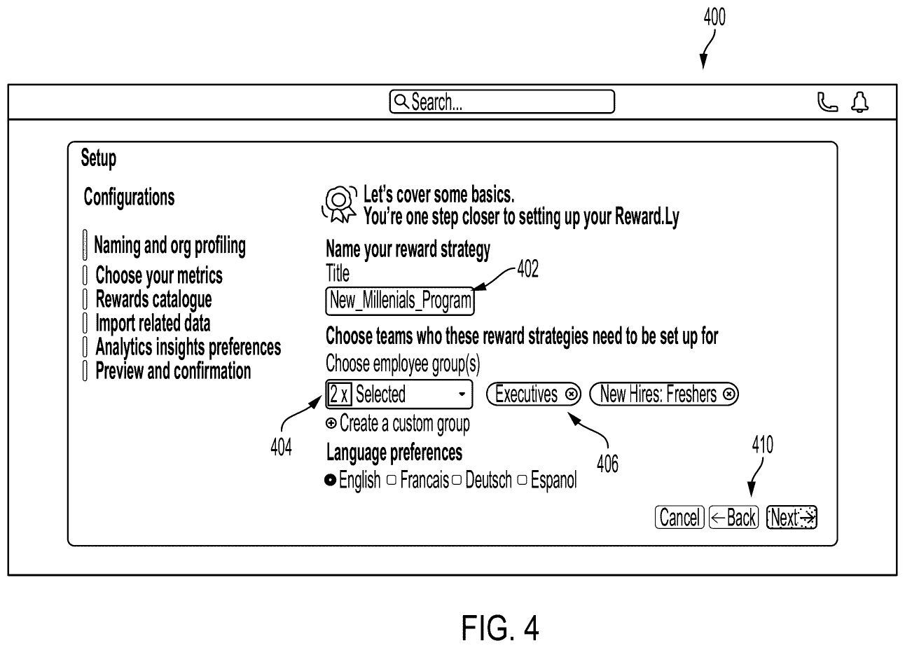

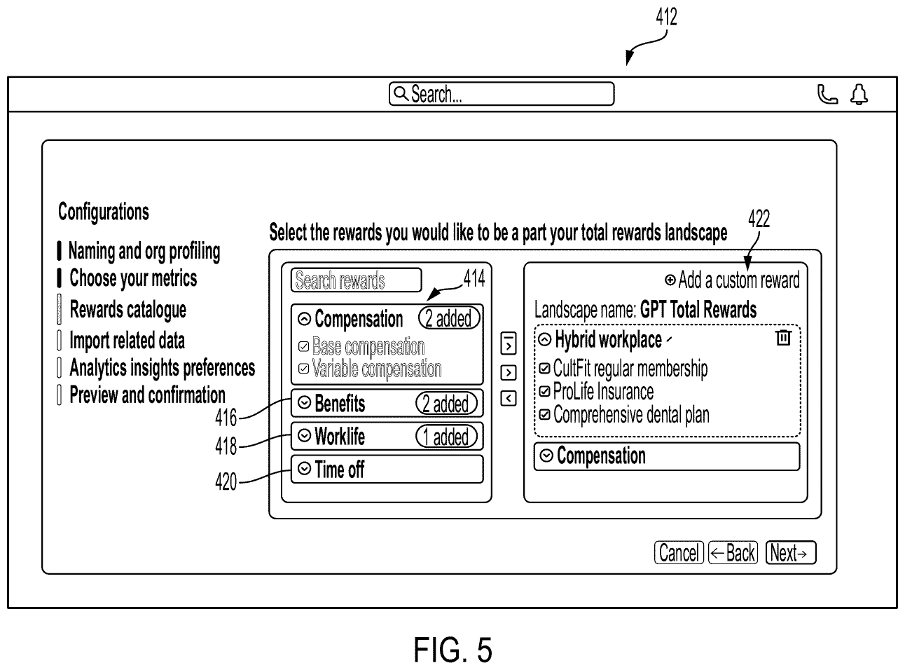

FIG. 4 is illustrative of a setup GUI 400 that may be displayed on the user device 210, 210A. The setup GUI 400 may be used to set up search criteria of employment data from one or more different sets of employment data. The setup GUI 400 may include text box 402 which allows the user to enter a title for the search, e.g., name a rewards or employment total compensation strategy. A drop-down box 404 allows a user to select an employee group, for example, executives and new hires (or any other demographics), which may be displayed at box 406. The setup GUI 400 may also allow the user to designate a particular language, for example English, at language preference selection 408. The setup GUI 400 may further include navigational buttons 410 to move backward to the previous GUI or webpage or to move forward to the next GUI or webpage or to cancel the set up. Once the user has entered data and made selections on the setup GUI 400, the user may click the next button 410 to move to the next GUI, which is illustrated in FIG. 5 as a select rewards GUI 412.

In FIG. 5, the select rewards GUI 412 allows the user to select one or more different criteria for comparison between organizations as described and defined herein. For example, portion 414 allows the user to select different employee rewards for comparison such as compensation, including base compensation and variable compensation. More specifically, the compensation may include basic compensation salary; whereas variable compensation may include bonuses based upon personal performance, business unit performance, on overall corporate performance, stock, stock options and any of a variety of other forms of compensation, etc.

Additional employee rewards may be selected at portions 416, 418, and/or 420. For example, portion 416 may include benefits such as healthcare insurance, dental insurance, vision insurance, 401K or other retirement contributions. Portion 418 may include work-life criteria such as a four-day work week, remote work location, hybrid on site and remote work arrangements. Portion 420 may include time off, e.g., maternity leave, sabbaticals, weeks of vacation or sick time, etc. Portion 422 may include a custom reward combination, e.g., a hybrid workplace, gym membership, pro-life insurance, and comprehensive dental plan as examples.

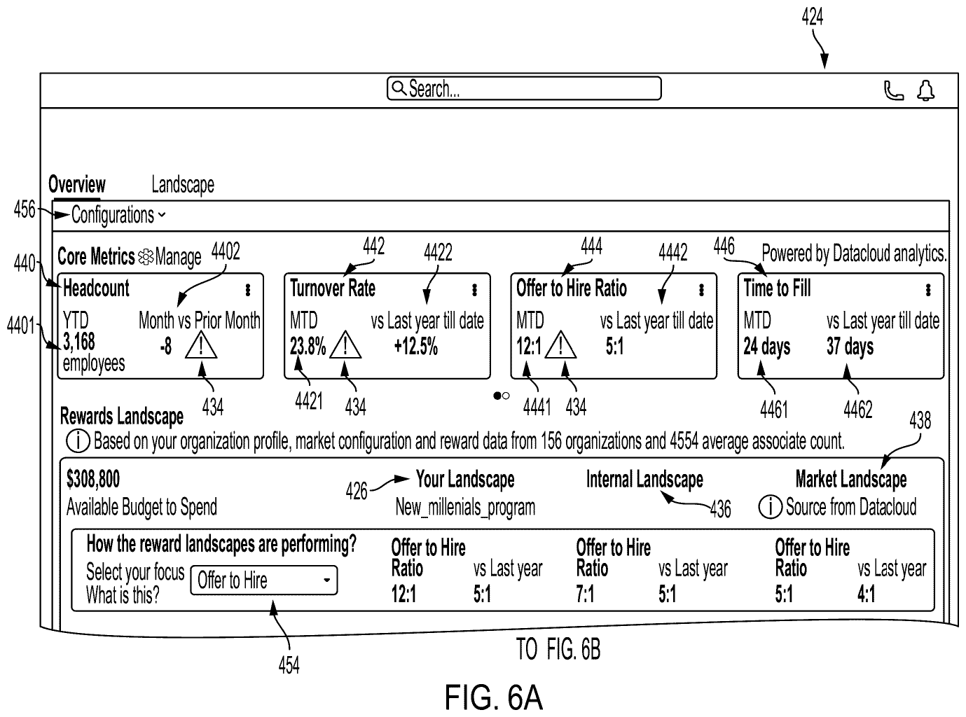

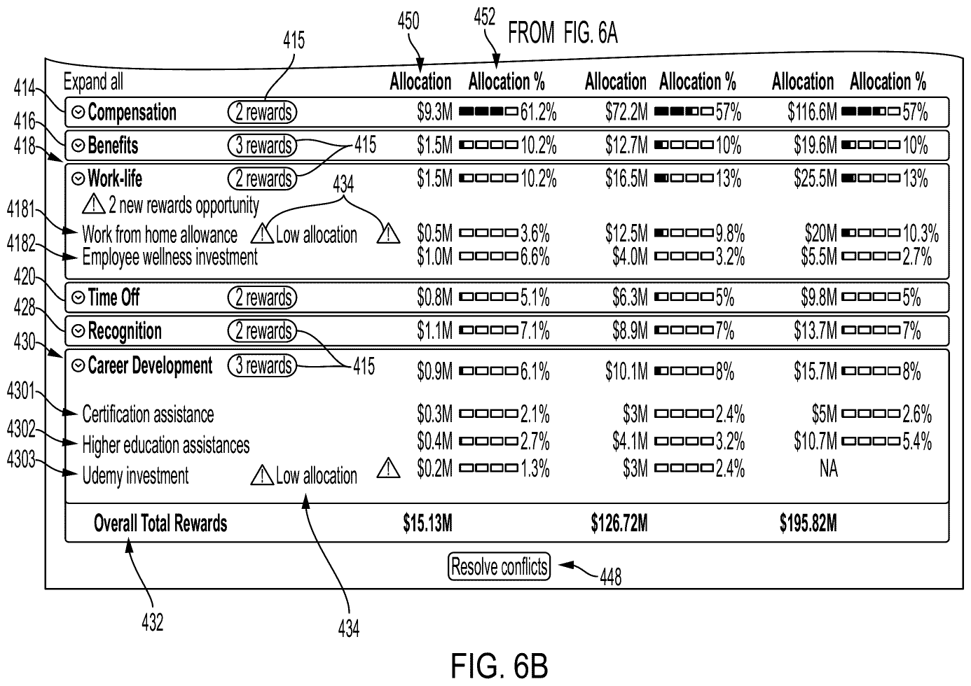

Upon completion of the user entering the different configuration settings on the select rewards GUI 412, the user can select the next button to request a comparison of the data as shown in FIGS. 6A and 6B, for example. In each operation of the GUIs described herein, the processor 115 of FIG. 1 may provide the required analysis and/or comparisons.

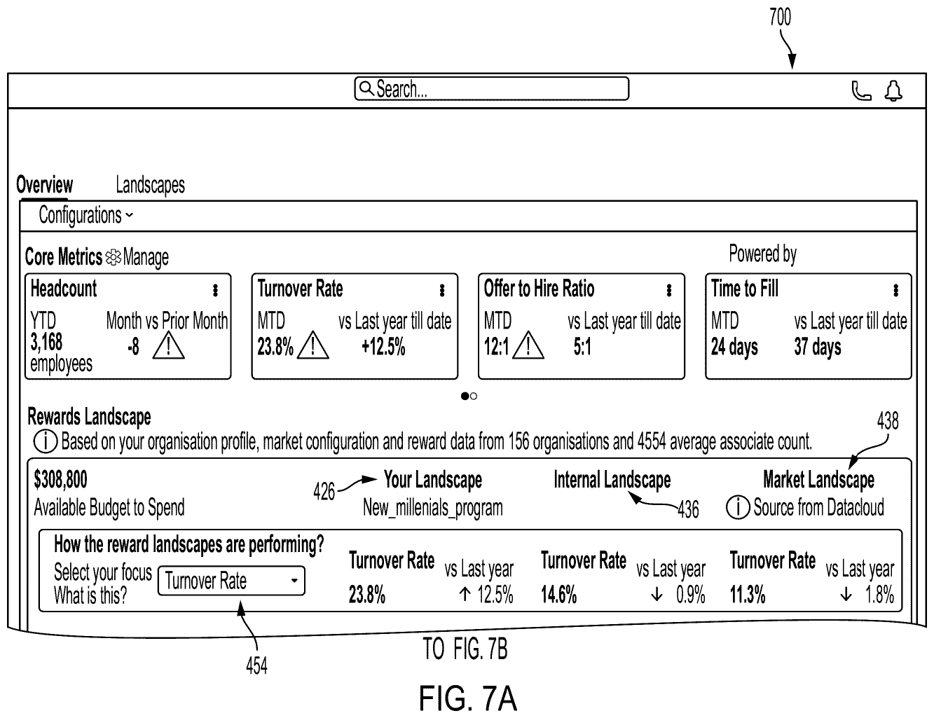

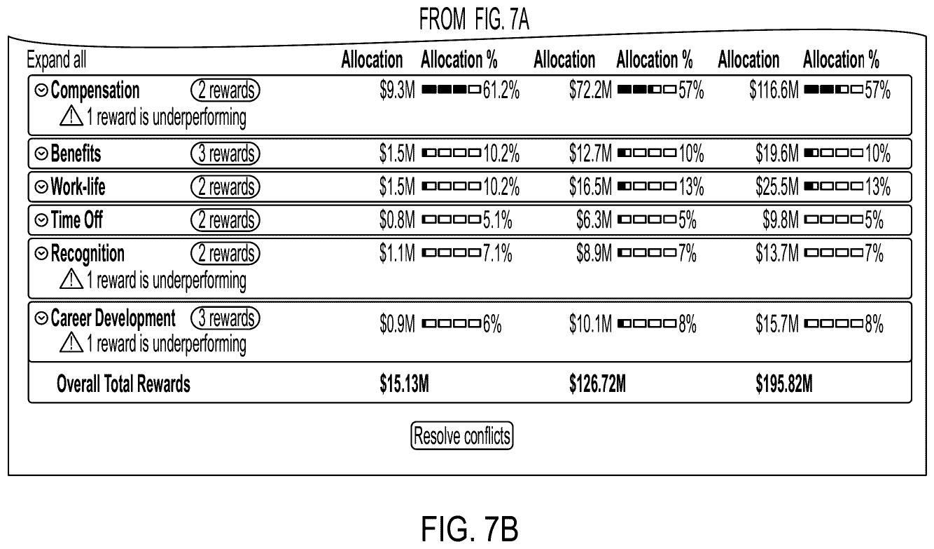

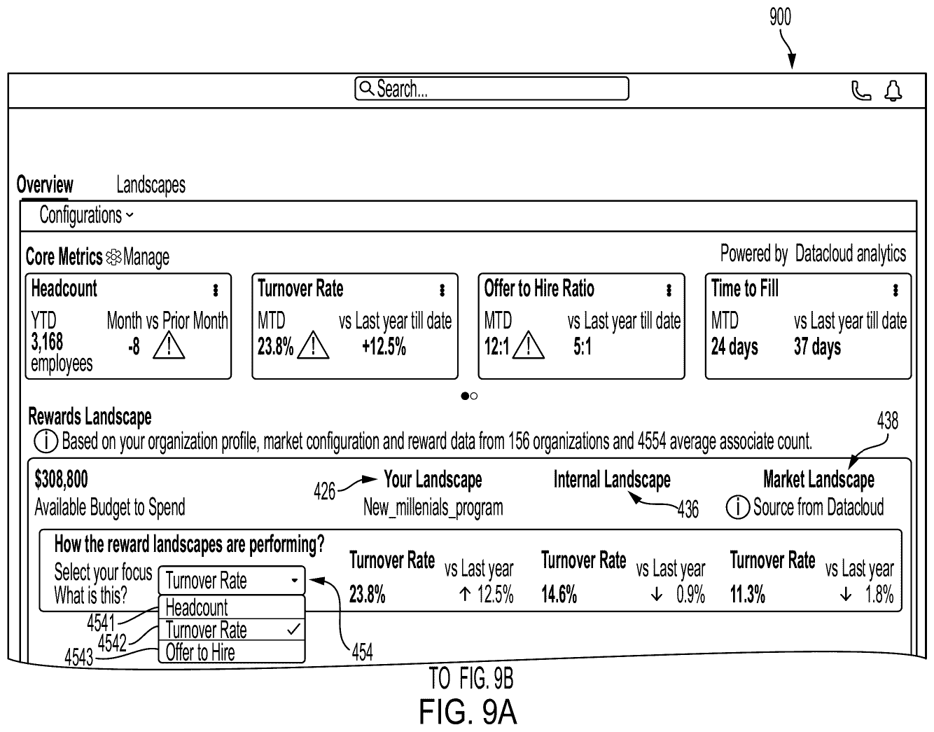

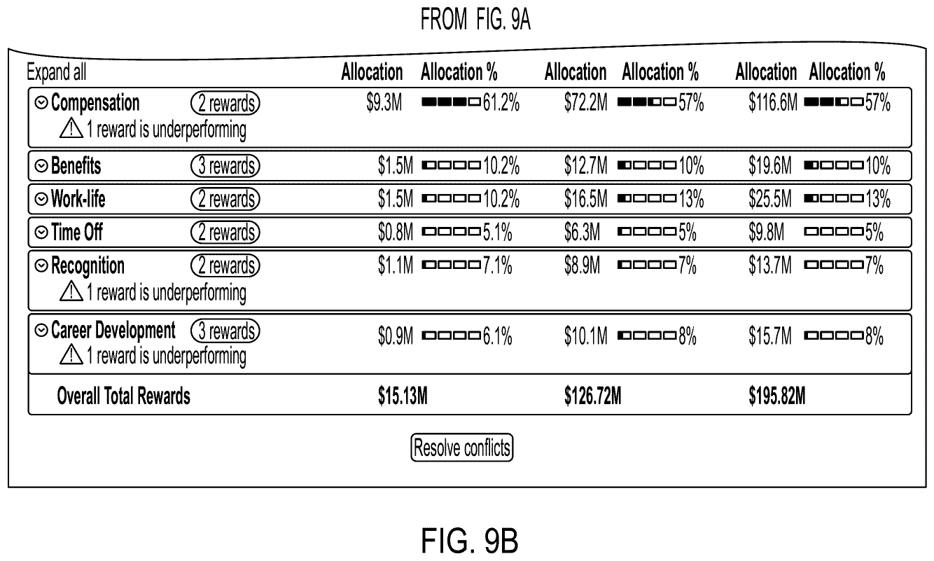

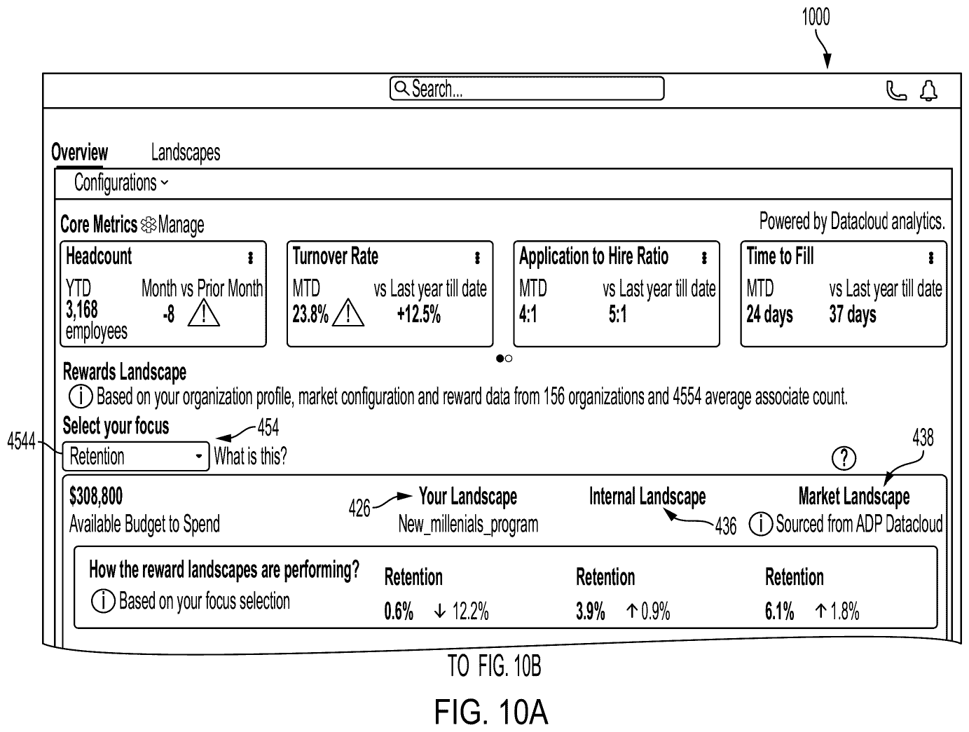

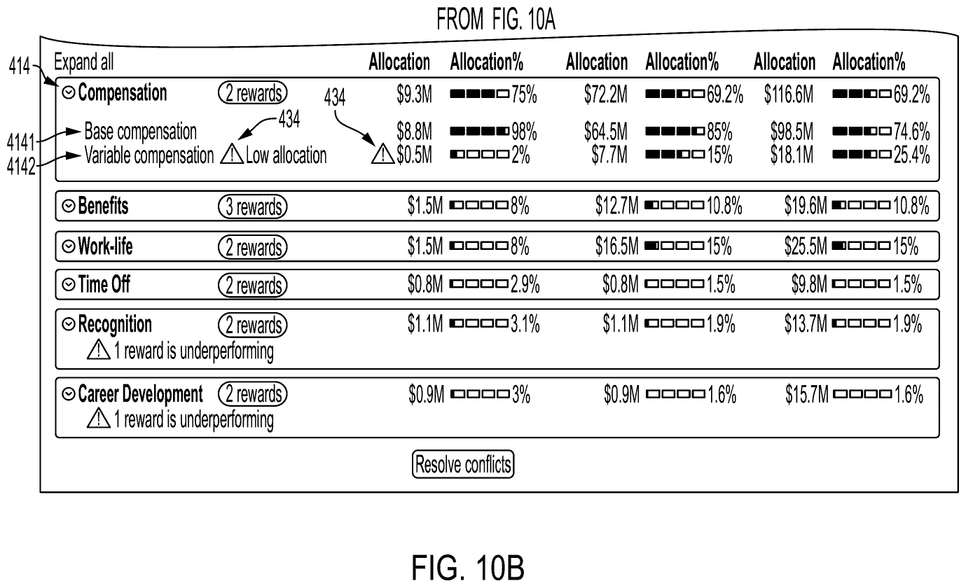

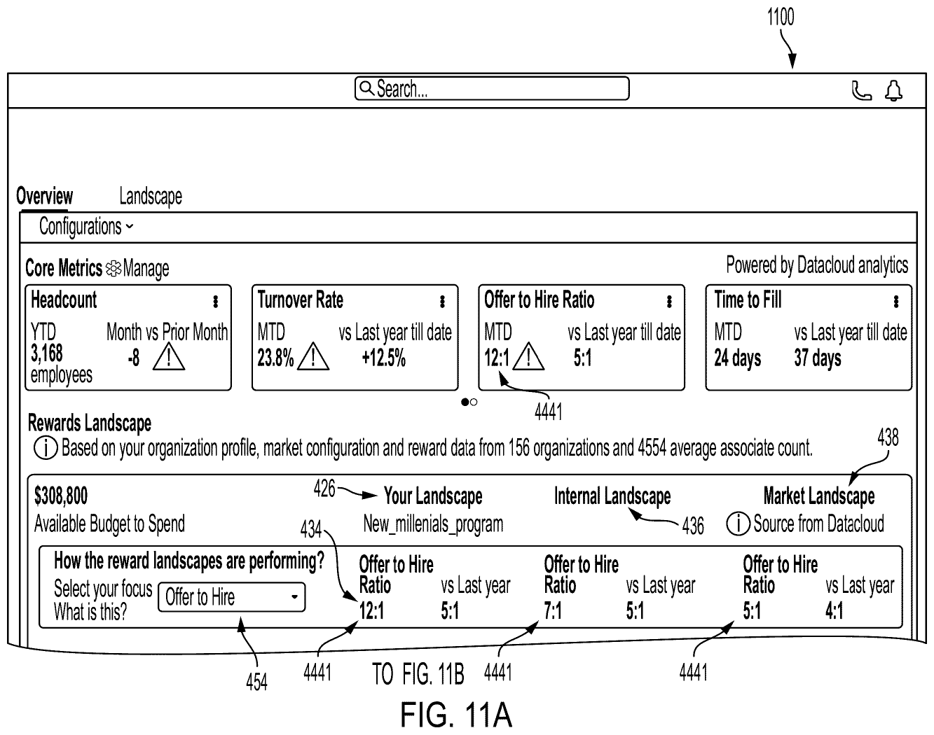

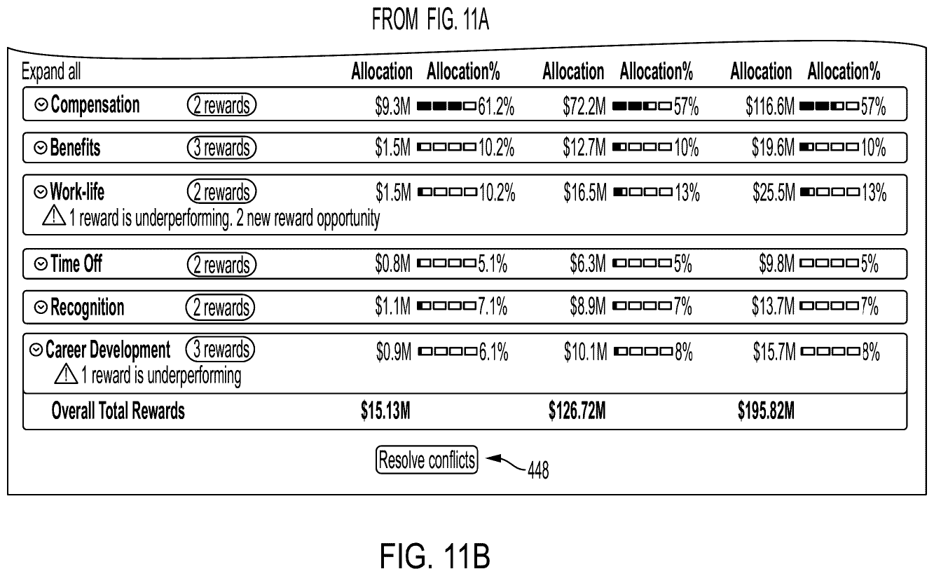

In FIGS. 6A and 6B, a comparative GUI 424 generates and displays the comparison of the configurations provided in FIG. 5 (e.g., your landscape) versus a column 436 and a column 438, using the different criteria of FIG. 5, e.g., compensation, etc. It should be understood that the comparative GUI 424 of FIGS. 6A and 6B, as well as any of the GUIs described herein, may be a comparison of different configurations (employee rewards) and criteria (e.g., different demographics) as provided in FIG. 5, in addition to different core metrics, e.g., turnover rate (FIG. 7A-9B) or retention (FIGS. 10A and 10B) or offer to hire (FIGS. 11A and 11B) or headcount (as shown in the drop down menu of FIGS. 9A and 9B), as examples. These comparisons may be used to provide recommendations for different compensation plans.

In FIGS. 6A and 6B, a drop-down menu 454 may be used for the user to select a category (core metric) for comparison, e.g., offer to hire. The comparison may also be based on other core metrics (also referred to as human resources metrics) such as retention, headcount, turnover rate, etc. The comparative GUI 424 displays an additional drop-down menu 456 which allows the user to select different configurations or demographics, e.g., age group, technical field, length of time the people have worked in the fields (tenure), type of pay such as hourly or salary, whether the people work full time or part time, or any of a variety of other categories or identifications, etc.

In response to the request by the user from selection in the drop-down menus 454, 456, the computer system 100 carries out actions including selectively collecting, sorting data, calculating, analyzing, and determining results as in each of the different GUIs. By way of example, the comparative GUI 424 shown in FIGS. 6A and 6B, may compare different information in a first column 426 associated with a landscape of a selected criteria, e.g., new millennium program, industry, average tenure, pay time employment type (full time vs. part time), etc., a second column (internal landscape of an entire organization) and a third column 438 (a market landscape associated with the marketplace, in whole). The comparison of different information may include different employee rewards as previously defined/selected by the user, e.g., portion 414, portion 416, portion 420, column 438, career development component 430 and overall total rewards 432, each of which may have been selected through the GUI of FIG. 5.

In further embodiments, each of the columns 426, 436, and 438 may display the allocation in dollar amounts 450 of a specific component of an employment budget, and may also display the allocation percentage 452 of a specific component of the employment budget. In this way, the columns 426, 436, 438 allow the user to compare different criteria amongst the different organizations, e.g., their landscape, internal landscape and market landscape).

In these implementations, it is possible to determine the sensitivity of the selected criteria to different human resource metrics. For example, it may be determined that variable pay is more sensitive to a higher attrition rate than base pay. Alternatively, it may be determined that lack of medical benefits is more sensitive to a higher attrition than variable pay, etc. In this way, an organization may determine, as suggested by systems and processes herein, to adjust their compensation rewards to lower the attrition rate, achieve higher hire ratios, etc. It may also be determined that some rewards, e.g., car allowances, gym memberships, etc. may not affect human resources' metrics such that these compensation rewards may be eliminated or interchanged with another reward that is predicted to improve the human resources metric.

In further embodiments, the comparative GUI 424 may generate and display flags 434. For example, the flags 434 may be in the form of symbols or text in a different color or format from the rest of the GUI 424. The flags 434 may be used to recognize and display differences in amounts, percentages, or other metrics within columns 426, 436, 438. For example, the flags 434 may be indicative that an employee reward for a particular landscape may be below or outside a predefined limit of the other landscapes. The comparative GUI 424 may also display indicators 415 that may be representative of other components, e.g., rewards, etc.

Additional comparisons associated with employee rewards may also be displayed, e.g., the portion 418 and related subcomponents, e.g., work from home allowance 4181, and employee wellness investment 4182. The career development component 430 may include the subcomponents, e.g., certification assistance 4301, higher education assistance, 4302, Udemy investment 4303. The comparative GUI 424 may further display core metrics associated with the employment budget such as headcount information 440 which may include the number of employees year to date 4401, and the percent change 4402 in headcount this month versus the prior month.

The comparative GUI 424 may further display comparisons between core metrics such as turnover rate information 442 including month to date percentage and last year till date percentage. The comparative GUI 424 may also display comparisons of additional core metrics, e.g., offer to higher ratio information 444 including month to date offer to hire ratio 4441 and last year offer to hire ratio this date 4442. In addition, the comparative GUI 424 may display additional core metrics including the average time to fill positions 446 for the business unit or group selected by or associated with the user, and may include the average month to date 4461 time to fill a position and the average last year this date time 4462 to fill a position. In this way, the comparative GUI 424 may generate and show comparisons of different employee rewards and core metrics in numerical format. The comparative GUI 424 may additionally include button 448 to request the computer system 100, e.g., processor 115 of FIG. 1, to resolve conflicts regarding components of the user's employment budget selected for a business unit or a group in the setup steps.

FIGS. 7A and 7B illustrate a comparative GUI 700 in which the user has selected the core metric of turnover rate from the drop-down menu 454 to be the focus of the comparative analysis. The components of the employment budget may be flagged based upon the core metric selected from dropdown menu 454.

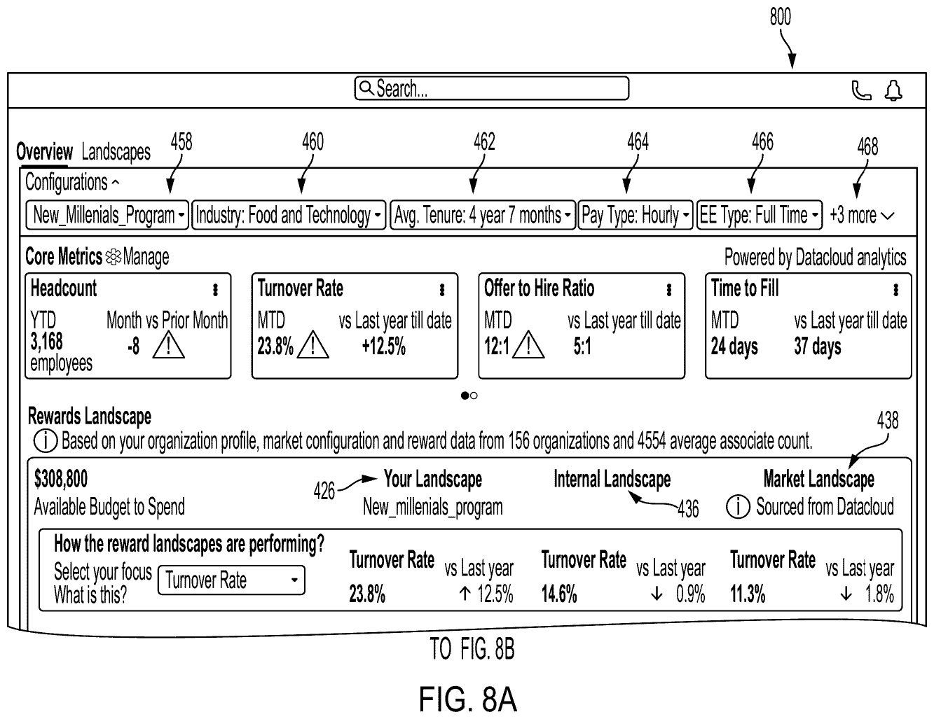

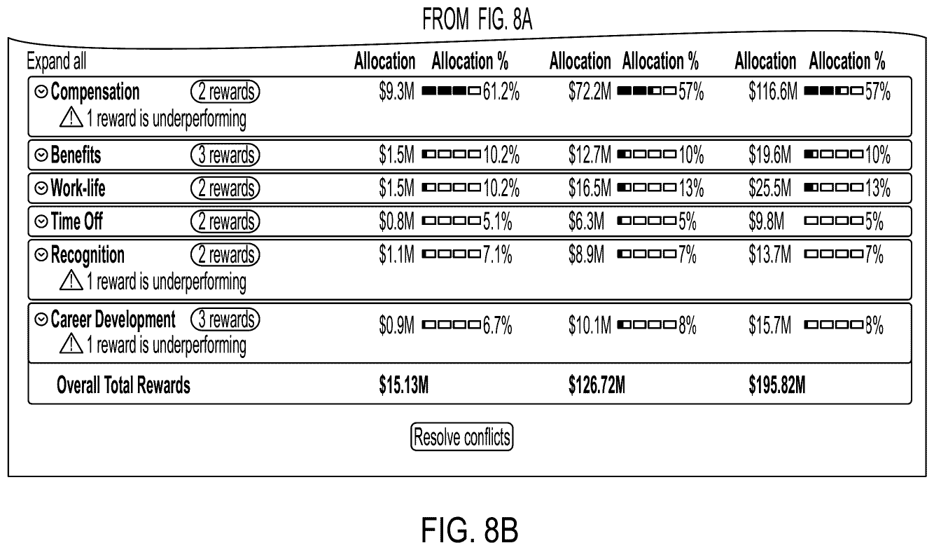

FIGS. 8A and 8B illustrate a comparative GUI 800 which generates and displays a comparison including selected criteria (demographic configurations), e.g., at least one of an age group 458 (for example, new millennials); technical field 460 (e.g., Industry), the length of time the people have worked in the fields (tenure) 462; type of pay such as hourly or salary 464; or whether the people work full time of part time 466, amongst other criteria to compare as shown at reference numeral 468.

FIGS. 9A and 9B show comparative GUI 900 which generates and displays a drop-down menu 454 comprising several subcategories for comparison. These subcategories may include core metrics including headcount 4541, turnover rate 4542, or offer to hire ratio 4543.

FIGS. 10A and 10B illustrate a comparative GUI 1000 focused on the core metric of retention of an employee. For example, in response to the user selection of retention as a focus of comparison, the comparative GUI 1000 will generate and display a comparison of the set up information, e.g., compensation, benefits, work-life, etc., based on such selected criteria. For example, in this retention comparison, the portion 414 includes a flag 434 for the variable compensation 4142 being low compared to the variable compensation shown in column 436 and column 438.

FIGS. 11A and 11B illustrate a comparative GUI 1100 focused on a comparison of the core metric of offer to hire ratio. In the comparative GUI 1100, the flag 434 shows a comparison of the offer to hire ratio 4441 in column 426, 436 and 438.

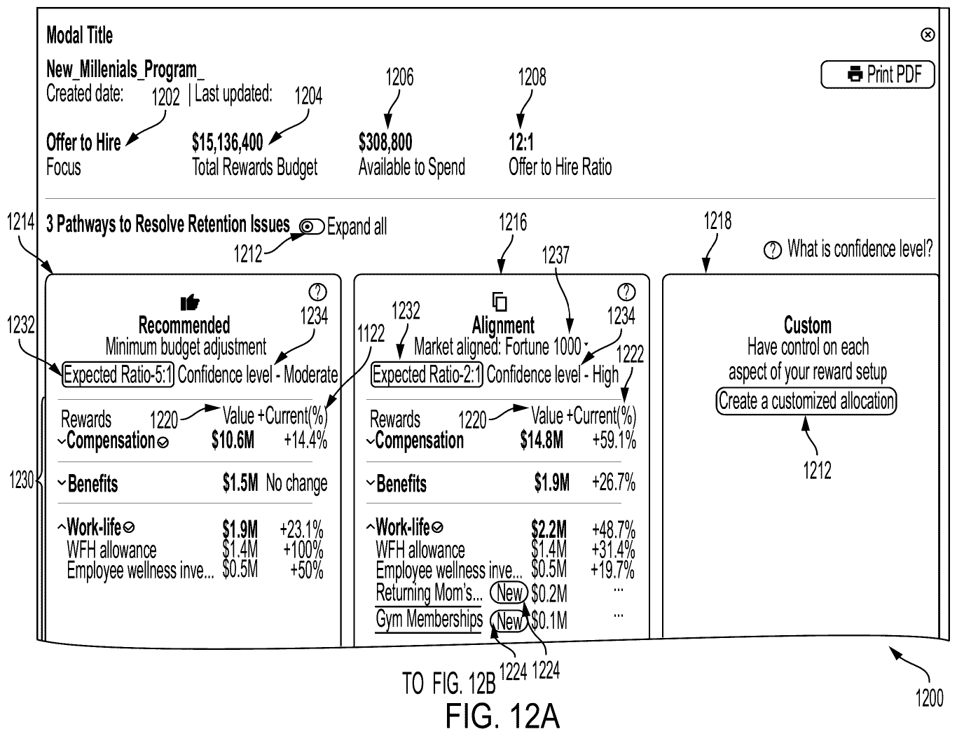

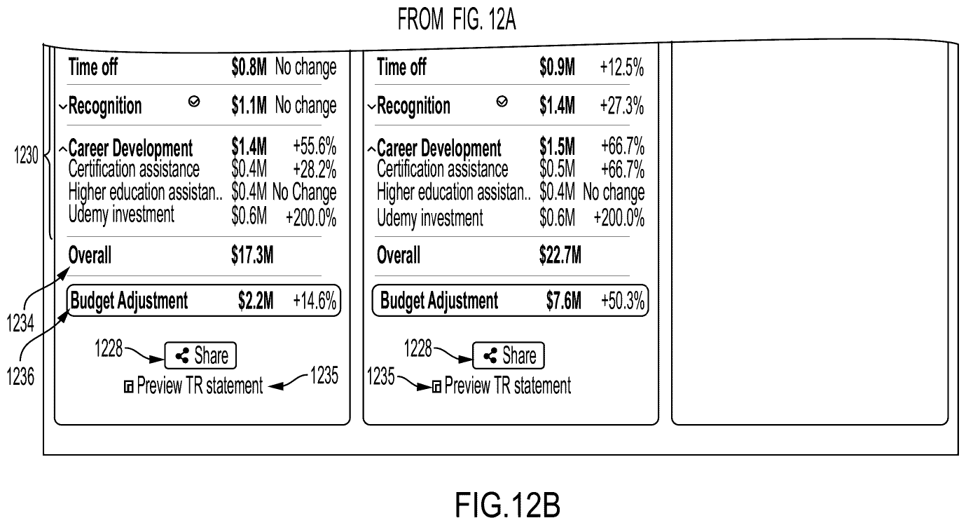

FIGS. 12A-16B depict several graphic user interfaces (GUIs) and related underlying functionality in accordance with aspects of the present disclosure. The displays may be provided on the devices 210, 210A of FIG. 2 or within the computer system 100 of FIG. 1, for example, and generated using the computing infrastructures/environments of FIGS. 1 and/or 2 by implementing the process flow of FIG. 3A and/or the process flow of FIG. 3B. For example, in each operation of the GUIs described herein, the processor 115 of FIG. 1 may provide the required analysis and/or comparisons. Moreover, it should be understood that the comparisons may be any number of sets of employee data and budgets. For example, the budgets may be values obtained from a comparison of organizations within the same or similar marketplace of comparable size, sales, profits, etc. using core metrics.

FIGS. 12A and 12B illustrate a GUI 1200 generated by the computer system 100 which displays a recommendation budget in column 1214, an alignment budget in column 1216, and a custom budget in column 1218, which may be expanded by selecting link 1212. The GUI 1200 may further display a core metric 1202, which may be the focus of the recommendations. In this example, the core metric 1202 is offer to hire; although other core metrics are also contemplated herein, e.g., turnover rate, retention, headcount, etc.

The GUI 1200 may generate a current total rewards budget 1204, which is the current budget of the organization, as well as a dollar amount that is available to spend at reference numeral 1206. The dollar amount that is available to spend may be additional funds available to the organization based on their current financial obligations and profit, for example. The financial obligations may vary, including current compensation, dividends, stock value or other valuation, etc. The GUI 1200 may also provide a ratio associated with a core metric such as offer to hire ratio at reference numeral 1208. And as should be understood by those of skill in the art, the GUI 1200 may be based on other criteria that was selected by the user in the GUIs of FIGS. 4 and 5.

Still referring to FIGS. 12A and 12B, the GUI 1200 may display three different paths to resolve a retention issue based on budgets. These paths may include the columns 1214, 1216, 1218, each of which represent different budgets. It should be recognized that other paths may be provided, e.g., two or more different paths, which may be expanded using link 1212. In embodiments, the paths include (i) column 1214 comprising a recommended employment benefits budget with a minimum budget adjustment, (ii) column 1216 comprising an alignment of a budget with respect to another organization or overall marketplace or any subset thereof selected by the user, and (iii) column 1218 comprising a customization of the employment benefits budget. The columns 1214, 1216, 1218 may include budgets based on a line-by-line comparison of different employee rewards as selected by the user and as defined at reference numeral 1230, e.g., compensation, benefits, work life, time off, recognition career development and subcategories.

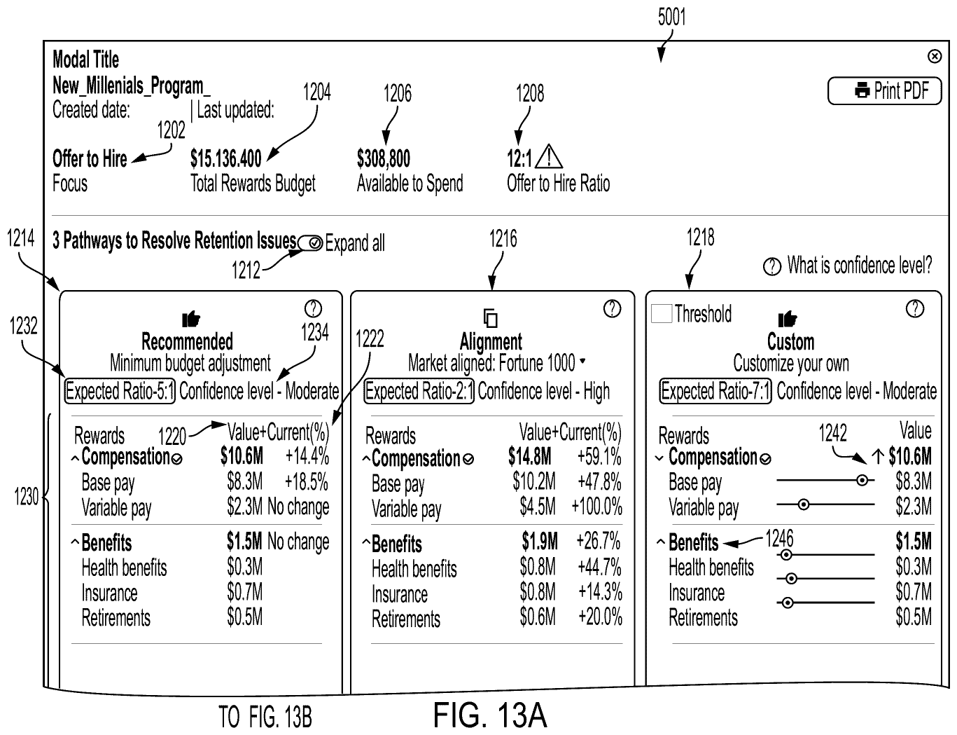

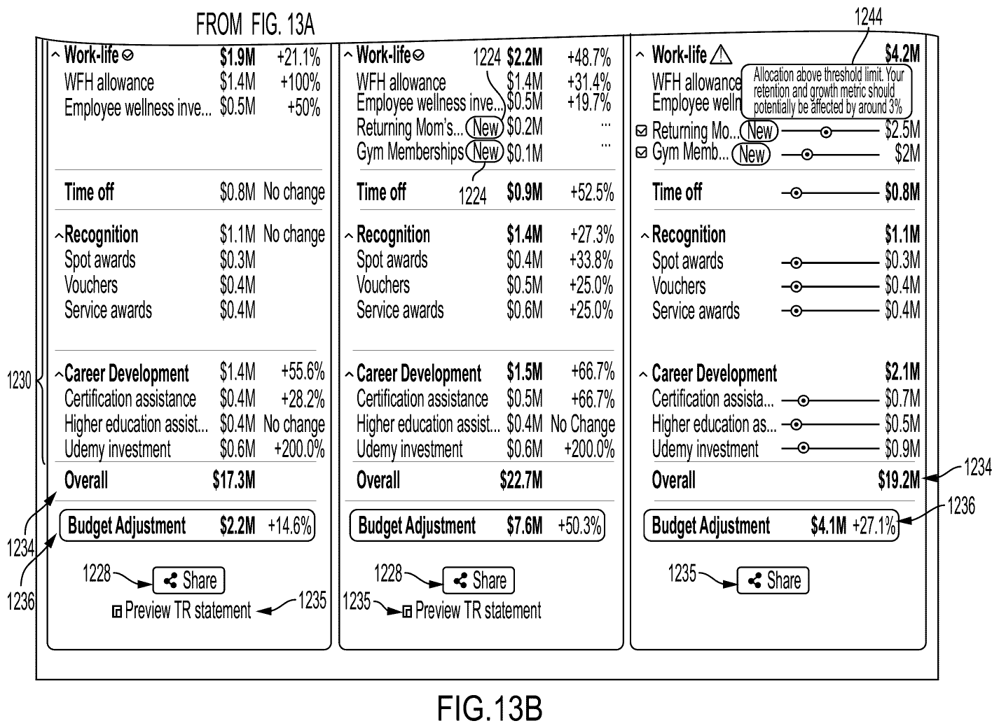

The columns 1214, 1216 (and column 1218 as shown in FIGS. 13A and 13B) may each include a predicted outcome 1232 and confidence level 1234 for each of the different budgets should they be adopted by the organization. For example, the recommended budget would have an expected ratio of 5:1 with a moderate confidence level of success, e.g., to retain employees, hire employees, be competitive in the marketplace, etc.; whereas a larger budget associated with aligned budget of the column 1216 would have a higher expected ratio of 2:1 with a high confidence level. Here, the predicted outcome 1232 for the recommended budget is less than the ratio of the aligned budget, and both of them are lower than the current offer to hire ratio shown at reference numeral 1208 associated with the current budget (without any modification or adjustment). It should be understood that the expected ratio may be substituted for comparison with different core metrics, as an example.

The confidence level 1234 may be indicative of achieving the predicted outcome for the employment metric that is the focus of the recommendation. A confidence level indicator of low, for example, would indicate a less than predetermined percentage, e.g., 60%, chance of being achieved. A confidence level indicator of moderate would indicate a greater than 60% but less than 80% chance of being achieved, as an example. And a confidence level indicator of high would indicate 80% or greater chance of being achieved, as an example.

In further embodiments, the columns 1214, 1216, 1218 of the GUI 1200 may include a column 1220 being allocated for each component (e.g., employee rewards 1230) and a percentage change 1222 indicating the percentage change for each component of the budget from the current budget. The dollar amount and the percentage change may be related to the many different employee rewards 1230 selected by the user. By way of example, the employee rewards 1230 may include: (i) compensation which may include subcategories of base pay and variable pay; (ii) benefits which may include subcategories of health benefits, insurance, and retirement; (iii) work-life which may include subcategories of work from home allowance, employment wellness investment, and gym membership; (iv) time off; (v) recognition which may include subcategories of spot awards, vouchers, and service rewards; and (vi) career development which may include subcategories of certificate assistance, higher education assistance, Udemy investment. The different employee rewards may be added to provide the confidence level 1234.

In further embodiments, each column 1214, 1216, 1218 of the GUI 1200 may include a budget adjustment 1236. The budget adjustment 1236 is a calculation based on either the recommended, aligned, or customized budget to the current budget. For example, in the present example, an adjusted budget of 2.2 million dollars in the column 1214 is the overall budget minus the current budget.

Colum 1216 may also include an indication of the type of market that is being compared to the current organization, as shown the budget adjustment 1236. In embodiments, the budget adjustment 1236 may display information regarding an organization such as, e.g., Fortune 1000 companies, etc. As should be understood by those of skill in the art, the column 1216 may be changed depending on the selected type of organization. For example, the values of the alignment budget may change based on a new selection of the market alignment indicator 1237. Illustratively, the market alignment indicator 1237 may be a drop-down menu providing the user an opportunity to select different groups within the overall market, such as, companies in the Standard and Poor's 500, NASDAQ 100, the Russell 2000 or any of a variety of other groups of companies.

The column 1216 may also include additional information at flag 1224. For example, the flag 1224 may be a highlighted word “New”, bringing to the user's attention additional subcategories of the employee rewards that are not currently provided for by the organization. These employee rewards may be, as example, gym membership, etc., any of which may consider additional rewards that may be provided by the organization and their associated costs, e.g., from a dollar amount shown in the column 1220.

The GUI 1200 of FIGS. 12A and 12B may further include an input link 1228 allowing the user to share a budget with another user such as, for example, a manager, human resource officer, etc. This feature may allow the user to share any of the recommendations by email or other electronic form in a report format. The GUI 1200 may also provide an input link 1235 allowing the user to share a preview of a total revenue (TR) statement by email or other electronic form.

FIGS. 13A and 13B shows a GUI 5001 with the custom column 1218 populated in response to selecting link 1212 in FIGS. 12A and 12B. More specifically, in FIGS. 13A and 13B, the GUI 5001 includes an expansion of the third column 1218 displaying data for a custom budget in which the user can customize different values of the employee rewards 1230 using slide control 1242. For example, as illustrated in FIGS. 13A and 13B, each of the column 1214, the column 1216, and the column 1218 may include a plurality of rows displaying corresponding budget data associated with the employee rewards 1230. In use, upon sliding or adjusting the slide control 1242, the dollar amount, e.g., value, for any of the employee rewards 1230 may be adjusted for comparison to the values in columns 1214, 1216. It should be understood that other controls may also be used, including the manual entry of the different values. The adjustments made to any of the employee rewards 1230 will recalculate the confidence level 1234 and the budget adjustment 1238.

In FIGS. 13A and 13B, a pop-up window 1244 may be generated and displayed indicating that a threshold limit set by the user may be exceeded. This pop-up window 1244 may also include additional subject matter based policies, legislation, legal compliance restrictions, or any company or government restrictions. The pop-up window 1244 may also include a prediction of how allocating more than the threshold limit may impact one or more metrics and may also provide a prediction of a percentage impact on one or more employee rewards or other metric. A threshold limit symbol 1246 may also be provided on the slider control 1242.

Still referring to FIGS. 13A and 13B, each of the employee rewards 1230 of the column 1218 may have different sensitivities based on the core metrics used in the analysis, such as offer to hire ratio, or other criteria that affects the overall budget, etc. For example, an adjustment of the compensation by a specific amount to one employee reward may result in an automatic change in a dollar amount allocated for other employee rewards 1230. This uses, for example, an overall budget that is available to the organization or other factors as described herein. In further embodiments, a machine learning algorithm may learn over time based on previous changes to the budget and, using this information, adjust for the sensitivity of each employee reward for each core metric that is the focus of the budget. For example, the machine learning algorithm will learn over time that a change to the career development may have an effect on the work-life and may make adjustments accordingly. These adjustments may be overridden by the user.

In these implementations, it is possible to determine the sensitivity of the selected criteria to different metrics. For example, it may be determined that variable pay is more sensitive to a higher attrition rate than base pay. Alternatively, it may be determined that lack of medical benefits is more sensitive to a higher attrition than variable pay, etc. In this way, an organization may determine, as suggested by systems and processes herein, to adjust their compensation rewards to lower the attrition rate, achieve higher hire ratios, etc. It may also be determined that some rewards, e.g., car allowances, gym memberships, etc. may not affect human resources' metrics such that these compensation rewards may be eliminated or interchanged with another reward that is predicted to improve the human resources metric.

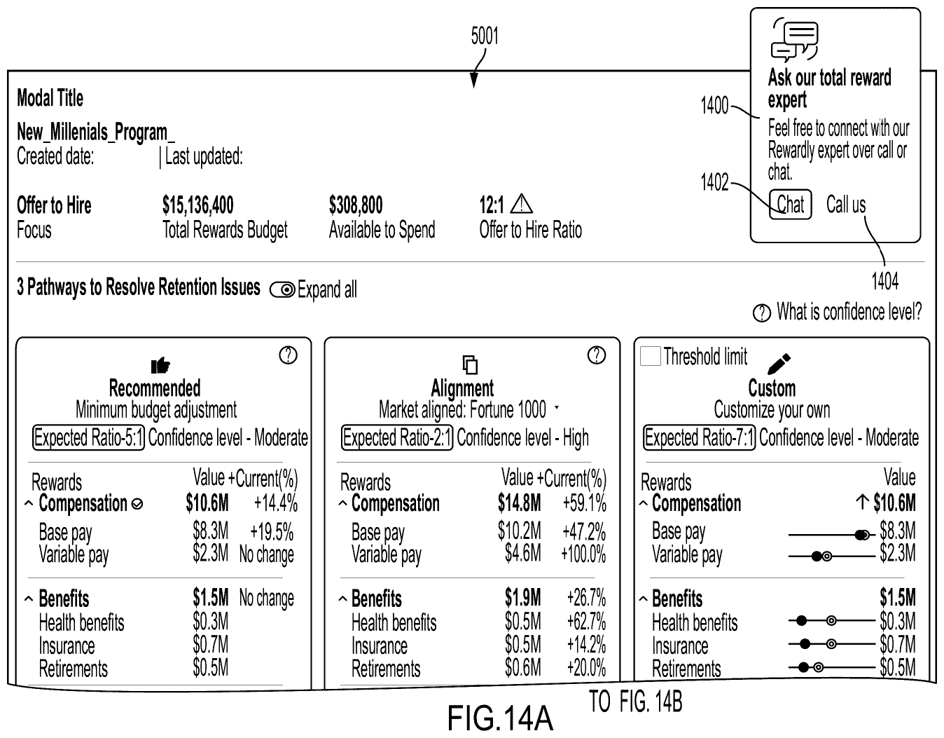

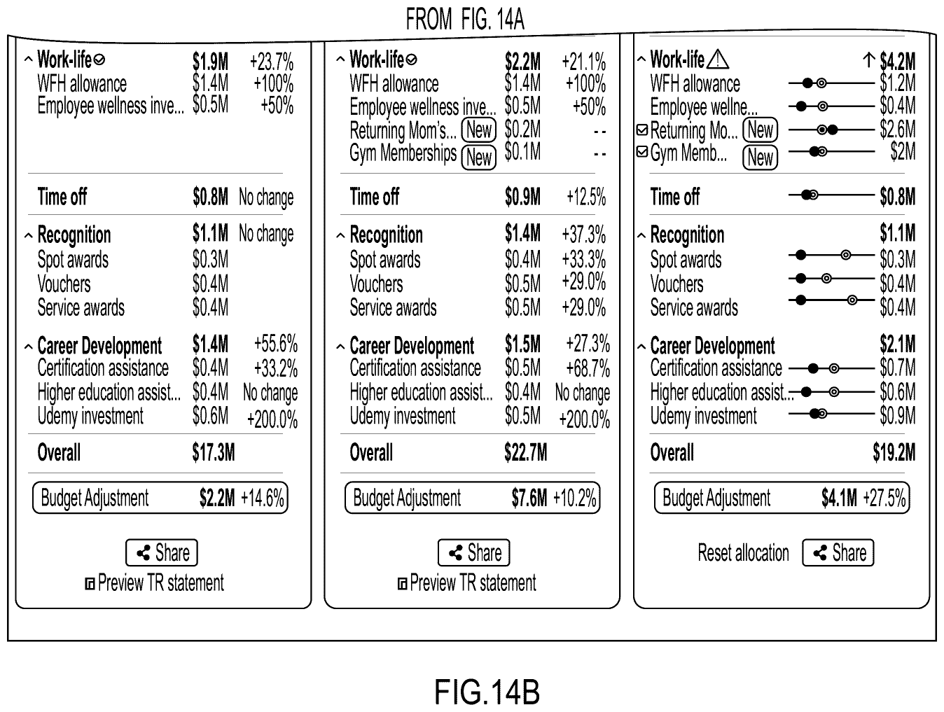

FIGS. 14A and 14B, show a pop-up message 1400 in GUI 5001. The pop-up message 1400 provides the user with the ability to either chat with an expert or call an expert as shown representatively at respective reference numerals 1402, 1404.

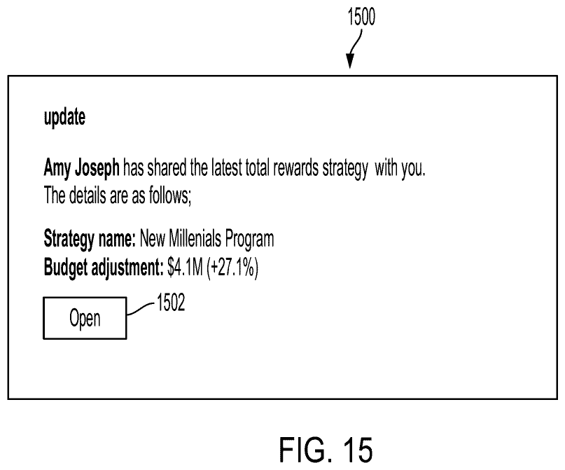

FIG. 15 shows a message 1500 that may be sent to a user, e.g., manager, human resources officer, etc. by selecting the input link 1228 provided in FIGS. 6A-8B. The message 1500 provides a brief description of the recommendation with the ability to open the report by selecting open selection 1502. In this way, it is possible to share the recommendations via a report, which can be displayed on a display of a user's device.

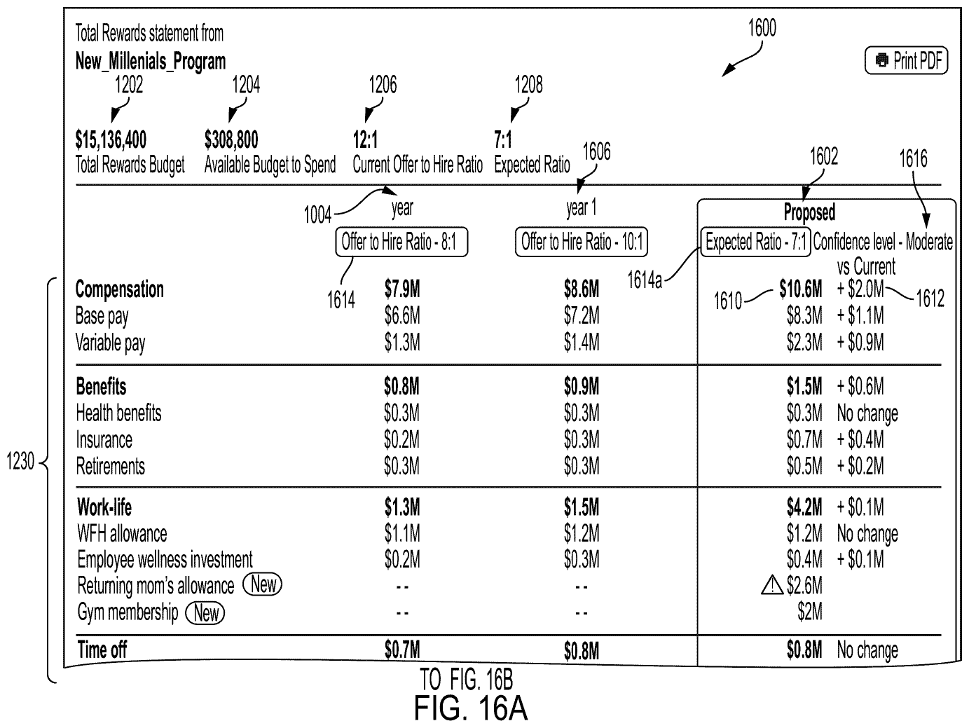

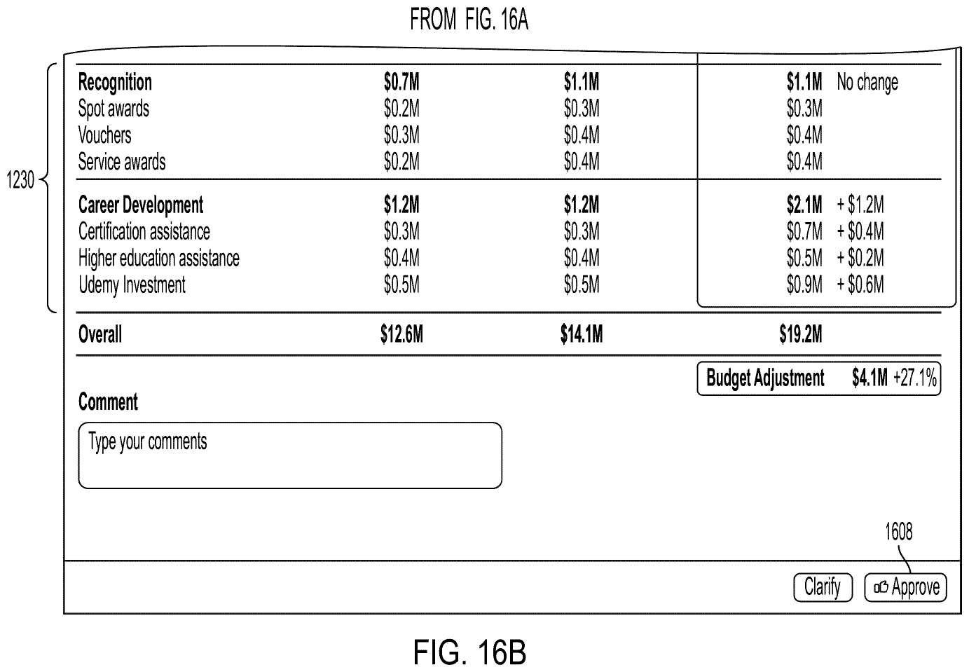

FIGS. 16A and 16B show a report 1600 which may be displayed to a user with a proposed employment benefits budget in column 1602 for an upcoming year, e.g., 2002, in comparison to budgets of previous years, e.g., 2020 in column 1604 and 2021 in column 1606. The report 1600 may include a link 1608 to approve the proposed budget. The proposed budget may include dollar amounts 1610 for each of the columns 1602, 1604, 1606, in addition to a change in dollar amount 1612 (or provided in other format such as a change in percentage). The report 1600 further shows the actual ratio to hire (or other core metric) 1614 for the previous years as shown in columns 1604, 1606, in addition to an expected actual ratio to hire (or another core metric) 1614a associated with the proposed budget in column 1602. The proposed budget may also include a confidence level 1616 associated with the proposed budget for the core metric.

FIG. 17 depicts a system architecture 1700 in accordance with aspects of the present disclosure. In embodiments, the system architecture 1700 includes user devices 210, 210A connected with computing systems 1710, 1712. The user devices 210, 210A may include, for example, an analyst device and chief human resource office device; although, it should be understood that different user devices may also be implemented by the present disclosure, e.g., associated with different analysts or administrators seeking information concerning employee retention, employee competitiveness and compensation, etc.

In embodiments, computing system 1710 may be the computer system 100 as shown in FIG. 1 and computing system 1712 may be representative of a cloud service comprising different microservices such as Apache, Docker, etc. Docket is an open-source software platform that helps simplify the process of creating, managing, running, and distributing applications. An external device 1713 may be connected to the computing system 1712 via an API.

Market data may be stored in database 1714. The market data may be provided to a data cloud 1715 and, more particularly, to a data table 1716 within the data cloud 1715. In embodiments, the data cloud 1715 may include databricks. As should be understood by those of skill in the art, the databricks are used for building, testing, and deploying machine learning and analytics applications to help achieve better business outcomes.

By way of example, the machine learning may be trained using already existing data in different databases 1722, e.g., business data provided from different, disparate systems such as human resources, benefits and payroll systems, etc. this training data may be rewards data, benefits data, etc. in any grouping or subgrouping of an organization, including the benchmark data. The training data may be normalized amongst the different systems, and may be used for establishing correlations between certain outcomes, e.g., retention rates, hiring ratio, etc., as described herein. For example, the different data can be provided into a standard format for learning and subsequently sorting, analyzing and comparing the data. In this way, it is now possible to determine a particular benchmark is being met or not being met such as how such data impacts hiring, retaining etc. In this way, it is possible to provide a practical application using the correlation and analysis of the data.

In embodiments, the machine learning algorithms may be, e.g., supervised, unsupervised, semi-supervised and reinforcement learning as is known in the art. For example, in supervised learning, the machine learns under supervision; it contains a model that is able to predict with the help of a labeled dataset (e.g., a labeled dataset is one where you already know the target answer). In unsupervised learning, the machine learning uses unlabeled data and learns on itself without any supervision by finding a pattern in the unlabeled data. Amongst other learning models, the present invention may also use K-Means clustering algorithms which are used to find groups which have not been explicitly labeled in the data. This can be used to confirm business assumptions about what types of groups exist or to identify unknown groups in complex datasets. It should be understood by those of ordinary skill in the art that other clustering techniques may also be used, e.g., density based clustering, mean shift clustering, etc. And by using the clustering techniques, eventually the correlations described herein and the different organizations used for the statistical analysis will cluster to form a correlation metric such as the attrition rate of employees based on a sampling of different reward compensation packages used as benchmarks for further analysis and comparisons to other organizations requesting correlation between their reward compensation packages and attrition, hiring ratio, retention, etc., and how changes in the compensation packages may positively affect their own metrics (e.g., attrition, hiring ratio, etc.).

The compared landscapes may be related to a particular subset of business units within an organization (e.g., given department or location or business unit of the same company), a general landscape of the organization and an entire marketplace (e.g., market/industry benchmarks in which the company is operating). The comparison may also include different core metrics (e.g., human resource metrics) such as headcount, turnover rate, offer to higher ratio, time to fill positions, retention rate, etc.

The different databases 1722 and/or different systems may be used to provide different employment information (e.g., employee rewards) to the data cloud 1715. The different databases 1722 may be systems associated with, for example, human resources, payroll, and benefits. In embodiments, the different databases may be, e.g., Lifion®, Workforce Now®, ADP Vantage HCM® and ADP Enterprise HR®, and their data may be segregated into different corresponding SSOT table, e.g., within the data cloud 1215. Lifion, Workforce Now and ADP Vantage empower clients to effectively address business challenges with a flexible, secure and integrated HCM solution that supports the full spectrum of HR needs, from recruitment to retirement and everything in between. ADP Enterprise HR provides outsourced enterprise payroll and HR (human resources), plus customization, insights, and seamless integration with other ADP products.

The data of the SSOT tables 1724 are provided/segregated into different domains 1726. These domains may include human resources, payroll, benefits, recruitment, talent, etc. In this way, common data points can be provided with common nomenclatures and categories. The information of the domains 1726 is subjected to an ETL process (e.g., Extract, Transform, and Load) at reference numeral 1728. For example, data is extracted from its original source, transformed by cleaning it up, deduplicating it and combining it for processing, and then the data is loaded into the target database, e.g., stored in data table 1716.

The information of the different domains can be stored into the data table 1716 and fed or injected into a recommendation, insights, and benchmarking engine 1718, which processes the information in accordance with the present disclosure, e.g., compares the different employee rewards, and calculates different core metrics and differences in employee rewards, etc. as described herein. In embodiments, the functionality of the recommendation, insights, and benchmarking engine 1718 may be provided by the processor 115 shown in FIG. 1.

The recommendation, insights, and benchmarking engine 1718 may provide, for example, the comparisons and analysis as described herein, e.g., creating employment comparisons based on employment data such as employee rewards, core metrics and/or other categories as defined/requested by the user in different landscapes. For example, the recommendation, insight, and benchmarking engine 1718 may utilize algorithms and machine learning to perform the calculations, analysis, and comparisons described herein. In embodiments, the machine learning may be trained on using current information in the different database 1722 as already described herein. The analysis/comparisons may be stored in a rapid access data storage device 1720 so that such information can be obtained in near real-time response to devices 210, 210A to be displayed in the GUIs described herein.

As an example, which includes different types of rewards including, e.g., regular pay, overtime pay, stock compensation, deferred compensation equity, medical benefits, etc. Also, assume there are allowances, so each of these distributions can be provided in terms of dollar amount and percentage. Assume also an organization may distribute rewards in different ways, which would impact the employee such as, e.g., hiring, retention, etc.

The machine learning learns on the existing data for existing compensation schemes from different organizations and how these different compensation schemes have affected the hiring, retention, etc. of the employee. In this way, the machine learning can now be used to compare a current plan of an organization and establish a correlation between their rewards and how such rewards impact the employee in view of the trained data and known outcomes. In essence, the machine learning and artificial intelligence tie thousands of reward distributions to a particular human resource metric, e.g., hiring, retention, etc., and allows these metrics to be compared to an existing rewards plan of an organization in order to predict the outcome of the existing rewards plan, in addition to providing different scenarios to an organization with different predicted outcomes. In this manner, the organization may select a particular compensation scheme that would meet their particular needs, with the knowledge of certain predicted outcomes, e.g., attrition or hiring ratio of their employees based on a different compensation scheme.

As another example, several organizations within related fields and in a same geographic location have a similar number of employees, e.g., 10 employees, with an approximate $100,000 compensation plan for each employee within a certain category, e.g., job title or job responsibility. The compensation is divided into two categories: variable pay and base pay. In a first organization, the $100,000 is split evenly between the variable pay and base pay. This organization has an attrition rate of 2% per year. A second organization has a distribution of 70/30 split with a 10% attrition rate and a third organization has a distribution of 40/60 split with a 12% attrition rate. The machine learning has trained on this data, which can now be used as a benchmark for future analysis of different organizations seeking review of their compensation plans.

In this example, an average of this data may be used to determine which is the best split of their compensation plan that would lead to an attrition rate that is amenable to the organization seeking review. It is also possible to take the median or any percentile, e.g., 95th percentile, 25th percentile, etc. for this analysis. In this example, the systems and processes described herein (using machine learning and artificial intelligence) will use the current compensation scheme of the organization seeking review and, as a practical application, model different scenarios of the compensation scheme based on the benchmarks. These different scenarios can be used to compare and allocate their compensation packages in a most efficient manner with a tolerable, expected attrition rate or hiring ratio, as compared to the benchmarks. For example, the processes and systems may recommend the organization seeking review to emulate another organization, or adjust their compensation to improve their human resources metrics, etc. By way of practical application, a recommendation may be made to increase base pay with improved medical plans (but remove a car allowance or gym membership).

By way of an example use case, organization XYZ may prioritize reward distributions into a certain order of importance, e.g., base pay is prioritized over gym membership. Historically, a particular reward distribution has resulted in an offer to hire, in addition to an acceptance rate and turnover rate of a certain percentage, e.g., 55% and 25% respectively. With this information, by using the tools described herein, it is possible to analyze the reward distribution to known correlations already established and learned earlier, and to map the reward distributions to a benchmark of external reward distributions. Using this mapping function, the tools can provide a recommendation as to different reward distributions which would result in a decreased turnover rate and increased acceptance rate.

Moreover, using the tools described herein, it is now possible to provide a market alignment strategy. This market alignment strategy essentially provides organization XYZ with options to align itself with respect to a particular set of employees. These particular set of employees can be any desired organization, whether it be a fortune 500 company, a company within a selected industry, selected geographic location, etc. Accordingly, the organization XYZ can select from any number of different employee sets for market benchmarks.

From the selected market benchmarks, the tools can provide a comparison of the turnover rate and acceptance rate to any of the market benchmarks. This comparison will show a side-by-side comparison of the particular reward distributions to the similar reward distributions for the benchmark (e.g., selected set of employees). Using this as a starting point, the organization XYZ may take several different options. For example, organization XYZ may align their strategy to that benchmark or other company or may want to customize the recommendations to achieve a different budget.

By way of example, organization XYZ may adjust levels of one or more of their rewards, e.g., base pay, bonuses, vacation days, remote work, etc. to determine how this may affect acceptance and turnover rate. For example, by changing levels of distribution, it is now possible to determine whether a particular line item is having a positive correlation with respect to the turnover rate or a negative correlation with respect to turnover rate. Accordingly, and as an illustration, it is now to determine whether base pay has a small a bigger delta in the turnover rate, compared to, e.g., a gym membership, which has a smaller delta in the turnover rate. Accordingly, it is now possible to provide a custom view, which can be adjusted in a granular fashion to determine how different factors may affect employee decisions in different ways.

The foregoing examples have been provided merely for the purpose of explanation and are in no way to be construed as limiting of the present disclosure. While aspects of the present disclosure have been described with reference to an exemplary embodiment, it is understood that the words which have been used herein are words of description and illustration, rather than words of limitation. Changes may be made, within the purview of the appended claims, as presently stated and as amended, without departing from the scope and spirit of the present disclosure in its aspects. Although aspects of the present disclosure have been described herein with reference to particular means, materials and embodiments, the present disclosure is not intended to be limited to the particulars disclosed herein; rather, the present disclosure extends to all functionally equivalent structures, methods and uses, such as are within the scope of the appended claims.

1. A system comprising one or more memory devices storing instructions thereon that, when executed by one or more processors, cause the one or more processors to:
receive, from a cloud system, training data to indicate correlations between a plurality of parameters of a plurality of entities and a plurality of metrics of the plurality of entities;
train, using the training data, a machine learning model to identify the correlations between the plurality of parameters and the plurality of metrics;
detect, via a display device, a selection to indicate a change to a first parameter associated with a first entity of the plurality of entities;
identify, using the machine learning model, a second plurality of metrics associated with the first parameter, wherein the machine learning model identifies the second plurality of metrics responsive to a detection of a plurality of correlations between the first parameter and the second plurality of metrics;
transmit, to the cloud system, a first Application Programming Interface (API) call to receive first values associated with the second plurality of metrics, wherein the first values pertain to the first entity;
generate, using the machine learning model, a prediction to indicate a plurality of changes to the first values responsive to implementation of the change;
generate, responsive to generation of the prediction, a user interface to identify the plurality of changes; and
display, via the display device, the user interface.

2. The system of claim 1, wherein the instructions further cause the one or more processors to:
generate the training data by monitoring changes to values associated with the plurality of parameters to determine changes to values associated with the plurality of metrics; and
segment the training data into a plurality of portions based on a plurality of characteristics of the plurality of entities.

3. The system of claim 2, wherein the detection of the plurality of correlations between the first parameter and the second plurality of metrics occurs responsive to the machine learning model identifying characteristics of the first entity.

4. The system of claim 1, wherein the prediction to indicate the plurality of changes to the first values responsive to implementation of the change is based on the plurality of correlations between the first parameter and the second plurality of metrics.

5. The system of claim 1, wherein the training data is absent information to identify the plurality of entities.

6. The system of claim 1, wherein the instructions further cause the one or more processors to:
detect implementation of the change;
transmit, to the cloud system, a second API call to receive second values associated with the second plurality of metrics;
compare, responsive to receipt of the second values, the first values to the second values;
determine, responsive to comparison of the first values and the second values, a plurality of differences;
identify, based on the plurality of differences and the plurality of changes, a plurality of results with respect to the prediction; and
update, based on the plurality of results with respect to the prediction, the machine learning model to adjust an efficacy of the machine learning model.

7. The system of claim 1, wherein the user interface to identify the plurality of changes includes:
graphical representations to identify the plurality of correlations between the first parameter and the second plurality of metrics;
graphical representations to identify a trend with respect to the first parameter; and
graphical representations to identify a trend with respect to a second plurality of entities.

8. The system of claim 1, wherein the instructions further cause the one or more processors to:
prompt, via the display device, a user to select parameters pertaining to the first entity; and
detect, responsive to prompting the user, the selection of the first parameter associated with the first entity.

9. The system of claim 8, wherein the instructions further cause the one or more processors to prompt the user to select the parameters based on a persona of the user.

10. A method, comprising:
receiving, by one or more processing circuits, from a cloud system, training data to indicate correlations between a plurality of parameters of a plurality of entities and a plurality of metrics of the plurality of entities;
training, by the one or more processing circuits, using the training data, a machine learning model to identify the correlations between the plurality of parameters and the plurality of metrics;
detecting, by the one or more processing circuits, via a display device, a selection to indicate a change to a first parameter associated with a first entity of the plurality of entities;
identifying, by the one or more processing circuits, using the machine learning model, a second plurality of metrics associated with the first parameter, wherein the machine learning model identifies the second plurality of metrics responsive to a detection of a plurality of correlations between the first parameter and the second plurality of metrics;
transmitting, by the one or more processing circuits, to the cloud system, a first Application Programming Interface (API) call to receive first values associated with the second plurality of metrics, wherein the first values pertain to the first entity;
generating, by the one or more processing circuits, using the machine learning model, a prediction to indicate a plurality of changes to the first values responsive to implementation of the change;
generating, by the one or more processing circuits, responsive to generation of the prediction, a user interface to identify the plurality of changes; and
displaying, by the one or more processing circuits, via the display device, the user interface.

11. The method of claim 10, further comprising:
generating, by the one or more processing circuits, the training data by monitoring changes to values associated with the plurality of parameters to determine changes to values associated with the plurality of metrics; and
segmenting, by the one or more processing circuits, the training data into a plurality of portions based on a plurality of characteristics of the plurality of entities.

12. The method of claim 11, wherein the detection of the plurality of correlations between the first parameter and the second plurality of metrics occurs responsive to the machine learning model identifying characteristics of the first entity.

13. The method of claim 10, wherein the prediction to indicate the plurality of changes to the first values responsive to implementation of the change is based on the plurality of correlations between the first parameter and the second plurality of metrics.

14. The method of claim 10, wherein the training data is absent information to identify the plurality of entities.

15. The method of claim 10, further comprising:
detecting, by the one or more processing circuits, implementation of the change;
transmitting, by the one or more processing circuits, to the cloud system, a second API call to receive second values associated with the second plurality of metrics;
comparing, by the one or more processing circuits, responsive to receipt of the second values, the first values to the second values;
determining, by the one or more processing circuits, responsive to comparison of the first values and the second values, a plurality of differences;
identifying, by the one or more processing circuits, based on the plurality of differences and the plurality of changes, a plurality of results with respect to the prediction; and
updating, by the one or more processing circuits, based on the plurality of results with respect to the prediction, the machine learning model to adjust an efficacy of the machine learning model.

16. The method of claim 10, wherein the user interface to identify the plurality of changes includes:
graphical representations to identify the plurality of correlations between the first parameter and the second plurality of metrics;
graphical representations to identify a trend with respect to the first parameter; and
graphical representations to identify a trend with respect to a second plurality of entities.

17. The method of claim 10, further comprising:
prompting, by the one or more processing circuits, via the display device, a user to select parameters pertaining to the first entity; and
detecting, by the one or more processing circuits, responsive to prompting the user, the selection of the first parameter associated with the first entity.

18. The method of claim 17, further comprising:
prompting, by the one or more processing circuits, the user to select the parameters based on a persona of the user.

19. One or more non-transitory storage medium storing instructions thereon that, when executed by one or more processors, cause the one or more processors to perform operations comprising:
receiving, from a cloud system, training data to indicate correlations between a plurality of parameters of a plurality of entities and a plurality of metrics of the plurality of entities;
training, using the training data, a machine learning model to identify the correlations between the plurality of parameters and the plurality of metrics;
detecting, via a display device, a selection to indicate a change to a first parameter associated with a first entity of the plurality of entities;
identifying, using the machine learning model, a second plurality of metrics associated with the first parameter, wherein the machine learning model identifies the second plurality of metrics responsive to a detection of a plurality of correlations between the first parameter and the second plurality of metrics;
transmitting, to the cloud system, a first Application Programming Interface (API) call to receive first values associated with the second plurality of metrics, wherein the first values pertain to the first entity;
generating, using the machine learning model, a prediction to indicate a plurality of changes to the first values responsive to implementation of the change;
generating, responsive to generation of the prediction, a user interface to identify the plurality of changes; and
displaying, via the display device, the user interface.

20. The one or more non-transitory storage medium of claim 19, wherein the instructions further cause the one or more processors to perform operations comprising:
generating the training data by monitoring changes to values associated with the plurality of parameters to determine changes to values associated with the plurality of metrics; and
segmenting the training data into a plurality of portions based on a plurality of characteristics of the plurality of entities.

21-40. (canceled)
